(19) United States
(12) Patent Application Publication
(10) Pub. No.: US 2003/0217359 A1
(43) Pub. Date: Nov. 20, 2003

(54) Image processing apparatus, method of controlling the same and program

(75) Inventors: Hirokazu Ohi, Tokyo (JP); Yasuhiro Yokota, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/383,731

(22) Filed: Mar. 10, 2003

(30) Foreign Application Priority Data
Mar. 11, 2002 (JP) 2002-065592
Mar. 26, 2002 (JP) 2002-085508

(51) Int. Cl. G06F 9/445

(52) U.S. Cl. 717/174

(57) ABSTRACT

It is an object of the present invention to improve operability of an image processing apparatus that allows image scanning or image printout such as a copier, printer or FAX, etc. In order to attain the above-described object, the image processing apparatus according to the present invention that controls a plurality of programs stores a group identification information correspondence table that controls the correspondence between a program and group identification information indicating a group to which the program belongs and a display position correspondence table that controls the correspondence between a program and a display position of the corresponding tab. The image processing apparatus installs programs to be installed (S701), references the group identification information correspondence table and decides the presence/absence of other programs having the same group identification information as the group identification information of the programs to be installed (S704). When it is decided that the other programs exist, the image processing apparatus controls the display of tabs of the programs to be installed based on the display positions of the tabs of the other programs controlled according to the display position correspondence table (S706 to S711).

### FIELD OF THE INVENTION

The present invention relates to an image processing apparatus that allows image scanning or image printout such as a copier, printer or FAX, etc.

### BACKGROUND OF THE INVENTION

Conventionally, when a software program is installed in a device such as a personal computer (PC), icons and menus, etc., to start this program are additionally displayed on the desktop on a display. At this time, those icons and menus are added at the end of other icons or a menu list. Or those icons and menus are sorted according to the name, type or size of the program together with existing programs and then displayed. Furthermore, when locations of those icons and menus are changed, they can be moved to desired positions by drag & drop using a mouse.

On the other hand, when an installed program is uninstalled, it is of course possible to uninstall individual programs and if a plurality of pre-packaged programs are installed, it is also possible to uninstall all programs included in the package all at once.

Furthermore, there are also other methods for batch uninstall. For example, according to the technology disclosed in Japanese Patent Laid-Open No. 9-34755, it is possible to classify files stored in an external storage device installed in a computer system according to file extension, directory unit or access history and delete a plurality of files all at once.

However, the above-described conventional example has the following problems.

That is, changing the positions of icons and menus to start a program in the above-described conventional example is a method suitable for only a PC that has input means such as a display with a wide screen and mouse, whereas it may be not so suitable for an image processing apparatus that allows image scanning or image printout having only a touch display with low resolution and a narrow screen such as a copier, printer, FAX. With such a display, it is not possible to arrange many icons or a drag & drop operation is difficult or not provided at all.

Thus, when a program is installed for an image processing apparatus provided with such a display, it is possible to add “program selection means” such as a tab and icon at the end of the display of existing tabs, etc., but it is not so easy to move their locations freely as a PC.

Then, if those tabs and icons are added at the end of the display of the existing tabs and their location are not moved, tabs of programs related with one another are separated or displayed on different screen pages. If tabs are so displayed, it is difficult to find a desired program to be started or access that program.

Furthermore, with regard to uninstalling, there is no other way than uninstalling programs one by one in the above-described image processing apparatus and this may lead to misoperation. For example, if there is dependency among programs and they need to be updated simultaneously by uninstalling and reinstalling the programs, there may be a case that the user may forget uninstalling one program and fail to update.

Furthermore, the above-described image processing apparatus has not only the above-described problems of install/uninstall but also some problems with operability of an installed program. For example, with such an image processing apparatus, the display order of “changeover buttons” for changing screens of a plurality of program started by a selection operation of a plurality of program selecting means is often fixed. Furthermore, even if the display order is not fixed, the display order is only changed according to a predetermined algorithm (e.g., according to the program starting order or program operating frequency) and the user cannot freely set the display order of changeover buttons. Likewise, with regard to the program starting order, it just starts programs in predetermined order and the user cannot freely customize the order according to the environment, which is inconvenient.

### SUMMARY OF THE INVENTION

The present invention has been implemented in view of the above-described problems and it is an object of the present invention to improve operability of an image processing apparatus.

More specifically, it is a first object of the present invention to provide an image processing apparatus, a method and program therefore capable of improving operability related to installing/uninstalling of programs and installing/uninstalling programs safely.

It is a second object of the present invention to provide an image processing apparatus, a method and program therefore capable of flexibly changing the display of a changeover button on a screen for switching between screens of started programs order and the program starting order.

To attain the above-described first object, the image processing apparatus according to the present invention adopts the following configuration. That is, an image processing apparatus that controls a plurality of programs, including first storage means for storing a group identification information correspondence table that controls the correspondence between a program and group identification information indicating a group to which the program belongs, second storage means for storing a display position correspondence table that controls the correspondence between a program and a display position of the corresponding program selection means, installing means for installing programs to be installed, decision means for referencing the above-described group identification information correspondence table and deciding the presence/absence of other programs having the same group identification information as the group identification information of the above-described programs to be installed and display control means for controlling, when the above-described decision means decides that the above-described other programs exist, the display of the program selection means of the above-described programs to be installed based on the display positions of the program selection means of the other programs controlled by the above-described display position correspondence table.

Furthermore, the above-described display control means preferably controls the display of the program selection means of the above-described programs to be installed so that those program selection means are arranged within the same screen as that of the program selection means of the above-described other programs.

Furthermore, the above-described display control means preferably controls the display, when the program selection means of the programs to be installed are arranged within a screen causing the number of the program selection means to exceed a maximum number of program selection means to be arranged within the screen, in such a way that at least one of the program selection means within the screen other than the program selection means of the programs to be installed and the other programs is moved to other screen.

To attain the above-described first object, the image processing apparatus according to the present invention adopts the following configuration. That is, an image processing apparatus that controls a plurality of programs, including first storage means for storing a group identification information correspondence table that controls the correspondence between a program and group identification information indicating a group to which the program belongs, second storage means for storing a display position correspondence table that controls the correspondence between a program and a display position of the corresponding program selection means, input means for inputting group identification information corresponding to programs to be processed, decision means for referencing the above-described group identification information correspondence table and deciding the presence/absence of other programs having the same group identification information as the group identification information of the above-described programs to be processed and display control means for controlling, when the above-described decision means decides that the above-described other programs exist, the display of the program selection means of the above-described programs to be processed based on the display positions of the program selection means of the other programs controlled by the above-described display position correspondence table.

Furthermore, the above-described input means preferably includes display means for displaying a list of group identification information of programs already installed, selection means for selecting desired group identification information from the list of group identification information displayed on the above-described display means and setting means for setting the group identification information selected by the selection means for the programs to be processed.

The image processing apparatus according to the present invention to attain the above-described first object has the following configuration. That is, an image processing apparatus for controlling a plurality of programs, including storage means for storing a group identification information correspondence table that controls the correspondence between a program and group identification information indicating a group to which the program belongs, specification means for specifying programs to be uninstalled, first uninstalling means for uninstalling the programs to be uninstalled specified by the above-described specification means, decision means for referencing the above-described group identification information correspondence table and deciding the presence/absence of other programs having the same group identification information as the group identification information of the above-described programs to be uninstalled and second uninstalling means for uninstalling the other programs, when the above-described decision means decides that other programs exist.

Furthermore, the above-described second uninstalling means preferably includes display means for displaying the above-described other programs and instruction means for instructing execution of individual/batch uninstalling of the above-described other programs displayed by the above-described display means.

To attain the above-described first object, the image processing apparatus according to the present invention adopts the following configuration. That is, an image processing apparatus that controls a plurality of programs, including storage means for storing a group identification information correspondence table that controls the correspondence between a program and group identification information indicating a group to which the program belongs, input means for inputting group identification information, display means for referencing the above-described group identification information correspondence table and displaying group identification information input by the above-described input means and instruction means for instructing uninstalling of all the above-described programs displayed by the above-described display means.

To attain the above-described first object, the control method according to the present invention adopts the following configuration. That is, a control method for controlling a plurality of programs, including an installing step of installing programs to be installed, a deciding step of referencing a group identification information correspondence table that controls the correspondence between a program and group identification information indicating the group to which the program belongs and deciding the presence/absence of other programs having the same group identification information as the group identification information of the above-described programs to be installed and display controlling step of controlling, when it is decided in the above-described deciding step that the above-described other programs exist, the display of the program selection means of the above-described programs to be installed based on the display positions of the program selection means of the other programs controlled by the display position correspondence table that controls the correspondence between a program and the display position of the corresponding program selection means.

To attain the above-described first object, the control method according to the present invention adopts the following configuration. That is, a control method for controlling a plurality of programs, including an inputting step of inputting group identification information corresponding to programs to be processed, a deciding step of referencing a group identification information correspondence table that controls the correspondence between a program and group identification information indicating the group to which the program belongs and deciding the presence/absence of other programs having the same group identification information as the group identification information of the above-described programs to be processed, and a display controlling step of controlling, when it is decided in the above-described deciding step that the above-described other programs exist, the display of the program selection means of the above-described programs to be processed based on the display positions of the program selection means of the other programs controlled by the display position correspondence table that controls the correspondence between a program and the display position of the corresponding program selection means.

To attain the above-described first object, the control method according to the present invention adopts the following configuration. That is, a control method for controlling a plurality of programs, including an specifying step of specifying programs to be uninstalled, a first uninstalling step of uninstalling the programs specified to be uninstalled in the above-described specifying step, a deciding step of referencing a group identification information correspondence table that controls the correspondence between a program and group identification information indicating the group to which the program belongs and deciding the presence/absence of other programs having the same group identification information as the group identification information of the above-described programs to be uninstalled, and a second uninstalling step of uninstalling the other programs, when it is decided in the above-described deciding step that the above-described other programs exist.

The second uninstalling step preferably includes a displaying step of displaying the above-described other programs and an instructing step of instructing execution of individual/batch uninstalling of the above-described other programs displayed in the above-described displaying step.

To attain the above-described first object, the control method according to the present invention adopts the following configuration. That is, a control method for controlling a plurality of programs, including an inputting step of inputting group identification information, a displaying step of referencing a group identification information correspondence table that controls the correspondence between a program and group identification information indicating the group to which the program belongs and displaying the programs having the group identification information input in the above-described inputting step and an instructing step of instructing uninstalling of all the above-described programs displayed in the above-described displaying step.

To attain the above-described first object, the program according to the present invention adopts the following configuration. That is, a program for allowing a computer to execute control processing for controlling a plurality of programs, including a program code in an installing step of installing programs to be installed, a program code in a deciding step of referencing a group identification information correspondence table that controls the correspondence between a program and group identification information indicating the group to which the program belongs and deciding the presence/absence of other programs having the same group identification information as the group identification information of the above-described programs to be uninstalled, and a program code in a display controlling step of controlling, when it is decided in the above-described deciding step that the above-described other programs exist, the display of the program selection means of the above-described programs to be installed based on the display positions of the program selection means of the above-described other programs controlled by the above-described display position correspondence table that controls the correspondence between a program and the display position of the corresponding program selection means.

To attain the above-described first object, the program according to the present invention adopts the following configuration. That is, a program for allowing a computer to execute control processing for controlling a plurality of programs, including a program code in an inputting step of inputting group identification information corresponding to programs to be processed, a program code in a deciding step of referencing a group identification information correspondence table that controls the correspondence between a program and group identification information indicating the group to which the program belongs and deciding the presence/absence of other programs having the same group identification information as the group identification information of the above-described programs to be processed, and a program code in a display controlling step of controlling, when it is decided in the above-described deciding step that the above-described other programs exist, the display of the program selection means of the above-described programs to be processed based on the display positions of the program selection means of the other programs controlled by the above-described display position correspondence table that controls the correspondence between a program and the display position of the corresponding program selection means.

To attain the above-described first object, the program according to the present invention adopts the following configuration. That is, a program for allowing a computer to execute control processing for controlling a plurality of programs, including a program code in an specifying step of specifying programs to be uninstalled, a program code in a first uninstalling step of uninstalling the programs specified to be uninstalled in the above-described specifying step, a program code in a deciding step of referencing a group identification information correspondence table that controls the correspondence between a program and group identification information indicating the group to which the program belongs and deciding the presence/absence of other programs having the same group identification information as the group identification information of the above-described programs to be uninstalled, and a program code in a second uninstalling step of uninstalling the other programs, when it is decided in the above-described deciding step that the above-described other programs exist.

To attain the above-described first object, the program according to the present invention adopts the following configuration. That is, a program for allowing a computer to execute control processing for controlling a plurality of programs, including a program code in an inputting step of inputting group identification information, a program code in a displaying step of referencing a group identification information correspondence table that controls the correspondence between a program and group identification information indicating the group to which the program belongs and displaying the programs having the group identification information input in said inputting step and a program code in an instructing step of instructing uninstalling of all the above-described programs displayed in the above-described displaying step.

Furthermore, to attain the above-described second object, the control method of the present invention adopts the following configuration. That is, a control method for controlling a plurality of programs executed by an image processing apparatus allowing image scanning or image printout, including a step of storing a changeover button display order table that specifies order in which changeover buttons for switching between screens of the plurality of programs being executed are displayed, a changeover button displaying step of displaying the changeover buttons based on the changeover button display order table, a step of storing a starting order table that defines order in which the plurality of programs are started, a starting step of starting the plurality of programs based on the starting order table and an editing step of editing the changeover button display order table and the starting order table individually.

Furthermore, the control method preferably further includes an editable controlling step of controlling the plurality of programs by dividing the programs into a predetermined number of groups, characterized in that the changeover button display order table can specify the changeover button display order in the units of groups.

Furthermore, the starting order table can preferably specify the starting order in the units of groups.

Furthermore, the controlling step is preferably characterized in that the plurality of programs are controlled in the units of groups.

Furthermore, the changeover button displaying step is preferably characterized in that when the changeover button display order table specifies only some of the plurality of programs, changeover buttons for switching between screens of those programs are displayed based on the display order specified in the changeover button display order table and changeover buttons for switching between screens of the remaining programs are displayed based on the starting order specified in the starting order table.

Furthermore, to attain the above-described second object, the image processing apparatus of the present invention adopts the following configuration. That is, an image processing apparatus having a plurality of programs and allowing image scanning and image printout, including means for storing a changeover button display order table that specifies order in which changeover buttons for switching between screens of the plurality of programs being executed are displayed, changeover button displaying means for displaying the changeover buttons based on the changeover button display order table, means for storing a starting order table that defines order in which the plurality of programs are started, starting means for starting the plurality of programs based on the starting order table and editing means for editing the changeover button display order table and the starting order table individually.

Furthermore, to attain the above-described second object, the program of the present invention adopts the following configuration. That is, a program for allowing a computer to execute image processing for controlling a plurality of programs executed by an image processing apparatus allowing image scanning and image printout, including a program code in a step of storing a changeover button display order table that specifies order in which changeover buttons for switching between screens of the plurality of programs being executed are displayed, a program code in a changeover button displaying step of displaying the changeover buttons based on the changeover button display order table, a program code in a step of storing a starting order table that defines order in which the plurality of programs are started, a program code in a starting step of starting the plurality of programs based on the starting order table and a program code in an editing step of editing the changeover button display order table and the starting order table individually.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate an embodiment of the invention and, together with the description, serve to explain the principles of the invention.

FIG. 1 is a block diagram showing a hardware configuration of an image processing apparatus of a first embodiment of the present invention;

FIG. 2 illustrates a program of the first embodiment of the present invention and group identification information associated with the program;

FIG. 3 illustrates a program of the first embodiment of the present invention and group identification information associated with the program;

FIG. 4 illustrates a display example of a program control screen of a display when a plurality of programs are installed in the image processing apparatus of the first embodiment of the present invention;

FIG. 5 illustrates another display example of the program control screen of the display when a plurality of programs are installed in the image processing apparatus of the first embodiment of the present invention;

FIG. 6 illustrates a display position correspondence table in the image processing apparatus of the first embodiment of the present invention;

FIG. 7 illustrates a group identification information correspondence table in the image processing apparatus of the first embodiment of the present invention;

FIG. 8 is a flow chart showing operation of installing a program in the image processing apparatus of the first embodiment of the present invention;

FIG. 9A is a flow chart showing operation of inputting or correcting group identification information later in the image processing apparatus of the first embodiment of the present invention;

FIG. 9B is a flow chart showing operation of inputting or correcting group identification information later in the image processing apparatus of the first embodiment of the present invention;

FIG. 10 illustrates a display example of a group identification information list screen of the image processing apparatus of the first embodiment of the present invention later;

FIG. 11 illustrates a display example of a group identification information input dialog of the image processing apparatus of the first embodiment of the present invention;

FIG. 12 illustrates a display example of a group identification information list selection screen of the image processing apparatus of the first embodiment of the present invention;

FIG. 13 is a flow chart showing operation of uninstalling a program from the image processing apparatus of the first embodiment of the present invention;

FIG. 14 illustrates a display example of a program list screen of the image processing apparatus of the first embodiment of the present invention;

FIG. 15 illustrates a display example of the same group program list screen of the image processing apparatus of the first embodiment of the present invention;

FIG. 16 is a flow chart showing operation of uninstalling a program by specifying a group from the image processing apparatus of the first embodiment of the present invention;

FIG. 17 illustrates a display example of a specified group program list screen of the image processing apparatus of the first embodiment of the present invention;

FIG. 18 is a block diagram showing a functional configuration of an image processing apparatus of a second embodiment of the present invention;

FIG. 19 is a block diagram showing a control function of a program manager in the image processing apparatus of the second embodiment of the present invention;

FIG. 20 illustrates an example of group setting data in the image processing apparatus of the second embodiment of the present invention;

FIG. 21 illustrates an example of changeover button display order data in the image processing apparatus of the second embodiment of the present invention;

FIG. 22 illustrates an example of starting order data in the image processing apparatus of the second embodiment of the present invention;

FIG. 23 illustrates an example of a screen showing program changeover buttons in the image processing apparatus of the second embodiment of the present invention;

FIG. 24 is a flow chart showing an example of a control procedure in the image processing apparatus of the second embodiment of the present invention;

FIG. 25 is a flow chart showing an example of a control procedure for displaying changeover buttons in the image processing apparatus of the second embodiment of the present invention;

FIG. 26 is a flow chart showing an example of a control procedure for executing a program in the image processing apparatus of the second embodiment of the present invention;

FIG. 27 illustrates an example of changeover button display order data in an image processing apparatus of a third embodiment of the present invention;

FIG. 28 illustrates an example of a screen when program changeover buttons are displayed in the image processing apparatus of the third embodiment of the present invention;

FIG. 29 is a flow chart showing an example of a control procedure in the image processing apparatus of the third embodiment of the present invention;

FIG. 30 is a flow chart showing an example of a control procedure for displaying changeover buttons of remaining groups not defined in the changeover button display order data in the image processing apparatus of the third embodiment of the present invention; and

FIG. 31 illustrates a memory map of a storage medium for storing program code groups of various CPU-readable control programs.

### DETAILED DESCRIPTION OF THE PREFERRED EMBODIMENTS

Preferred embodiments of the present invention will now be described in detail in accordance with the accompanying drawings.

(First Embodiment)

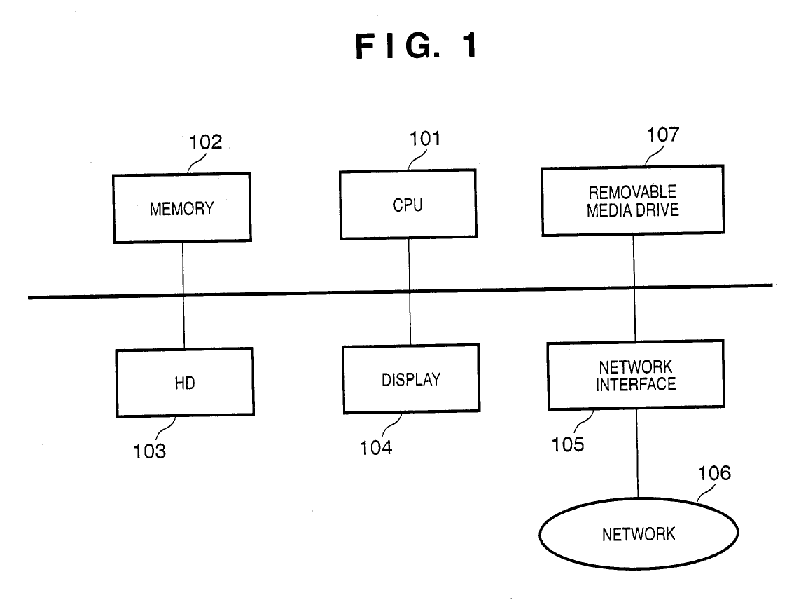

FIG. 1 is a block diagram showing a hardware configuration of an image processing apparatus of a first embodiment of the present invention, and more particularly a block diagram showing a hardware configuration of an image processing apparatus that allows image scanning or image printout such as a copier, printer or FAX, etc.

In the same figure, reference numeral 101 denotes a CPU, a central processing unit which controls the entire apparatus. The CPU 101 controls installing or uninstalling of a program, executes an installed program and performs various types of display control.

Reference numeral 102 denotes a memory, which stores various types of data such as group identification information showing the correspondence between a program and a group to which the program belongs and the correspondence between the program and the display positions on a display of program selecting means for selecting the program. This memory 102 also functions as a work area related to execution of the program and is realized by RAM or ROM, etc., according to the purpose of use.

By the way, the program selecting means for starting a program, etc., are a GUI (Graphic User Interface) parts drawn on the display and a button, icon, tab are some examples of those GUI parts.

Reference numeral 103 denotes a hard disk (HD), which stores various programs including a control program to realize a flow chart which will be explained below and various types of data. The hard disk 103 may also store data out of the data stored in a volatile portion of the memory 102 that must not be deleted when the power is turned off. Reference numeral 104 denotes a display with a touch panel (hereinafter simply referred to as “display”), which displays the program selecting means and the program itself.

Reference numeral 105 denotes a network interface, which takes charge of an interface with a network 106. Here, the network 106 may be wired or wireless or may take any forms using electricity, light, infrared rays. Reference numeral 107 denotes a removal media drive capable of connecting/disconnecting a storage medium (removal media: e.g., MO, Zip, DVD-RAM, memory card etc.) to exchange code or data with an external device.

The program to be installed in the image processing apparatus may be input through the network 106 or a program stored in the removable media may be input through the removable media drive 107. The present invention is also applicable to a case where a non-installed program stored in the HD 103 is installed.

Furthermore, various functions of the image processing apparatus may also be realized by the CPU executing a control program stored in the memory 102 or HD 103 or may also be realized by dedicated hardware.

Then, the group identification information associated with the program will be explained.

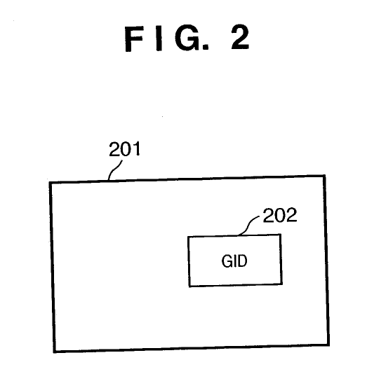

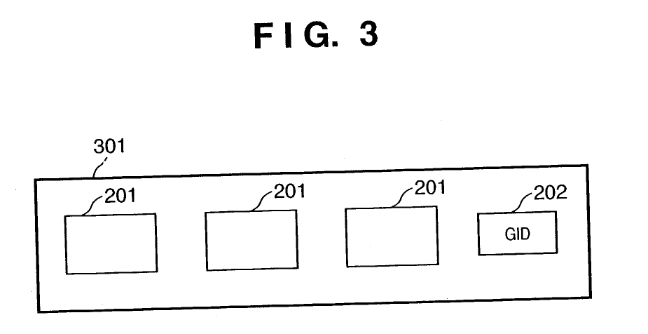

FIG. 2 and FIG. 3 illustrate a program of an embodiment of the present invention and group identification information associated with the program.

The group identification information refers to identification information indicating a group to which the program belongs. In FIG. 2, group identification information (GID) 202 exists inside a program 201.

On the other hand, in FIG. 3, one or a plurality of program groups 201 are stored in a program archive 301 and the group identification information 202 is stored together with those program groups. Though not shown in the figure here, the program archive 301 may further store various types of data and resources, etc.

In the program archive 301, installing or uninstalling is performed all at once. The group identification information of underlying programs 201 is expressed by the group identification information 202 included in the program archive 301 that contains the programs 201. That is, the group identification information 202 need not always be included in the programs 201 themselves. According to FIGS. 2 and 3, group identification information has existed in the program or in the program archive before the program is installed. However, it is not limited to this embodiment.

As shown above, since installing and uninstalling operations on the program archive 301 are the same as those on the programs 201, the present invention will be explained focused on the programs 201 hereunder.

Then, an example of screen display on the display 104 will be explained.

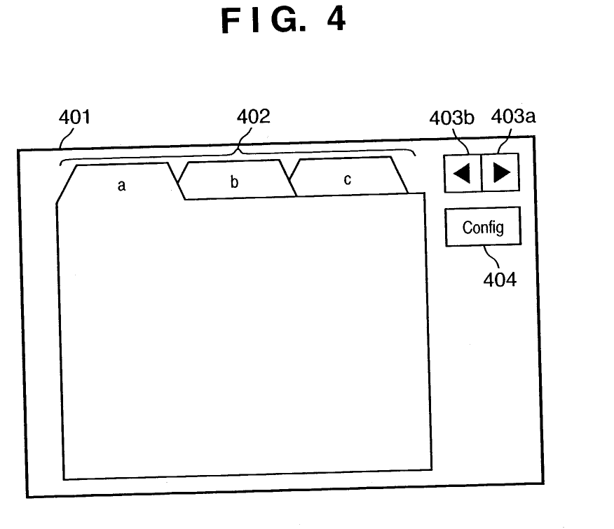

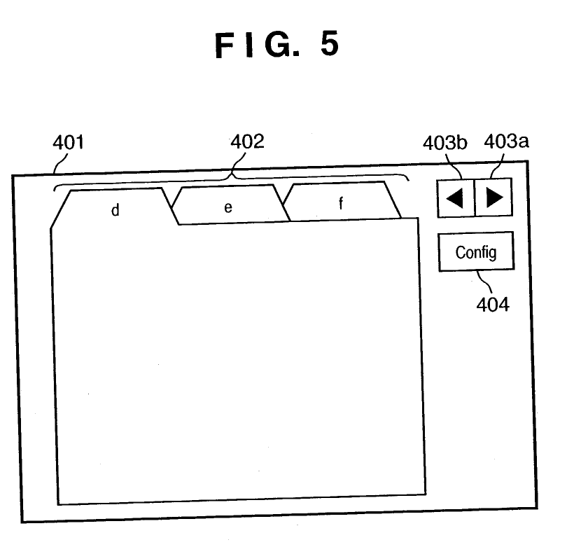

FIG. 4 and FIG. 5 illustrate a display example of a program control screen 401 of the display 104 when a plurality of programs are installed in the image processing apparatus of the embodiment of the present invention.

On the program control screen 401, reference numeral 402 denotes program selection tabs made up of a plurality of tabs, each tab corresponding to one program. Touching a desired one of these program selection tabs 402 makes it possible to change the tab to be displayed at the top of the screen displayed.

By the way, the present invention describes a case of using tabs as an example of the program selecting means, but it is obvious that similar effects can also be obtained when GUI parts other than tabs, for example, buttons, icons and other parts are used.

Reference numerals 403a and 403b denote screen page shift buttons. As the number of programs installed increases, so does the number of tabs. When many tabs are forced to be displayed on a single screen, spacing between tabs decreases and the selection operation becomes more difficult. Thus, an upper limit is set to the number of tabs displayed on one screen and when the number of tabs exceeds the upper limit, tabs are displayed on a plurality of pages. The rightward shift button 403a is pressed to show the next page and the leftward shift button 403b is pressed to show the previous page.

Reference numeral 404 denotes a Config button to control a program. Pressing this button shows a menu (not shown) to invoke various functions such as installing or uninstalling a program, correcting or confirming group identification information.

In this embodiment, suppose six programs a, b, c, d, e and f are installed in the image processing apparatus. FIG. 4 shows a display example of the initial program control screen 401 and FIG. 5 shows a display example of the program control screen 401 when this page is replaced by the next page. As is apparent from the figure, the initial program control screen 401 shows the program tabs a, b and c and the program control screen 401 on the next page shows the program tabs d, e and f.

This state is expressed as |a b c|d e f| and this expression will be used in subsequent explanations.

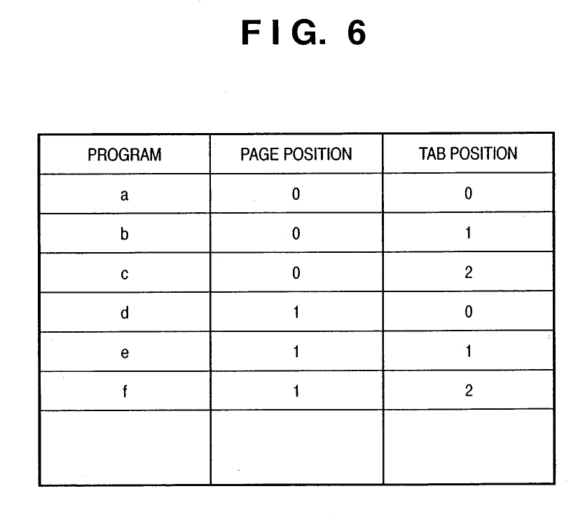

FIG. 6 illustrates a table for controlling the correspondence between a program and its page position and tab position stored in the memory 102 of the embodiment of the present invention (display position correspondence table).

The data of the page position and tab position is calculated relative to 0 as the origin. The states of FIG. 4 and FIG. 5 are expressed with the data shown in FIG. 6. When the display positions of the page and tab of a program change, the page position and tab position in FIG. 6 are also changed accordingly.

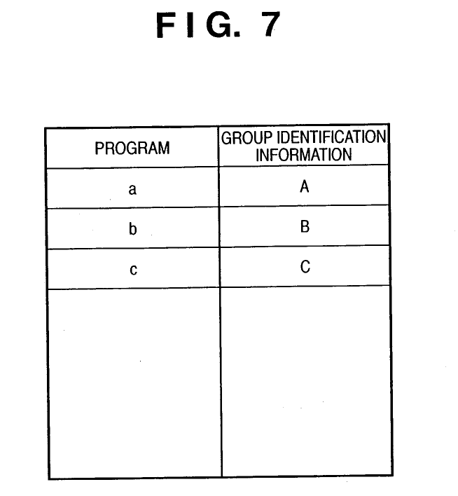

FIG. 7 illustrates a table for controlling the correspondence between a program and group identification information (group identification information correspondence table) stored in the memory 102 of the image processing apparatus of this embodiment of the present invention.

As shown in FIG. 7, group identification information of programs a, b and c is A, B and C, respectively. Other programs are omitted but their information exists.

The tables shown in FIG. 6 and FIG. 7 are also stored in the HD 103. They are also updated as required. Thus, when the power is turned off and on again, the same tab display and same group identification information as those before the power is turned off are guaranteed.

Then, various types of processing executed by the image processing apparatus will be explained using a flow chart.

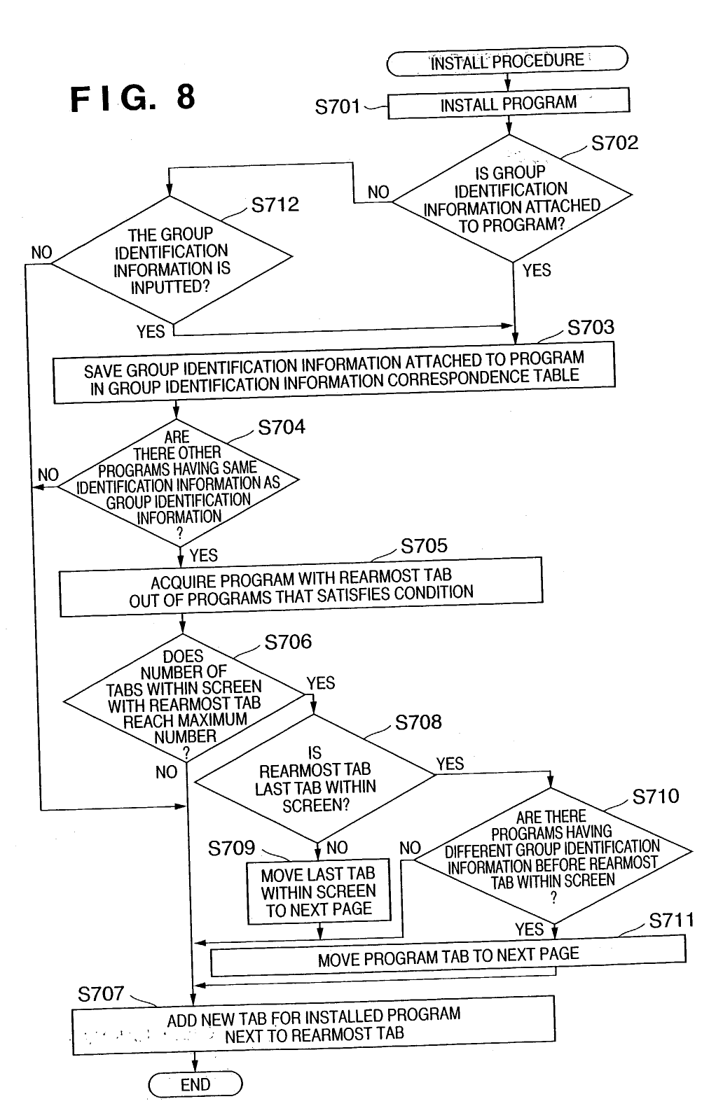

First, the operation when a program is installed in the image processing apparatus will be explained using FIG. 8.

FIG. 8 is a flow chart showing operation when a program in the image processing apparatus of this embodiment of the present invention is installed.

It is possible to install the program by pressing the Config button 404 on the program control screen 401 and then pressing the installation menu or start an installation function from the outside through the network 106. As described above, the program to be installed may also be stored in any one of the HD 103, the removal media loaded in the removable media drive 107 or network 106.

Once the installation is started, the CPU 101 starts a predetermined installation operation on the program (step S701). This includes, for example, procedures for placement of the program in a predetermined directory of the HD 103, opening of the program archive 301 or updating of the program control information.

Then, the CPU 101 decides whether any group identification information is attached to the program or not (step S702). When no group identification information is attached (NO in step S702), the CPU 101 decides whether the user input group identification information for the program (step S712). When the group identification information is not inputted, the CPU 101 adds a new tab for the installed program next to the rearmost tab among the program selection tabs 402 (the rearmost tab throughout the program in this case) (step S707) and ends the process.

On the other hand, when group identification information is attached (YES in step S702), or when group identification information is inputted by the user, the CPU 101 stores the group identification information in association with the program in the group identification information correspondence table (step S703).

Then, the CPU 101 references the group identification information correspondence table and decides the presence/absence of programs having the same group identification information as the group identification information in question (step S704).

When there is no program having the same group identification information (NO in step S704), the CPU 101 adds a new tab for the installed program next to the rearmost tab (the rearmost tab throughout all the programs in this case) (step S707) and ends the process.

On the other hand, when there are programs having the same group identification information (YES in step S704), the CPU 101 acquires the program whose tab is at the rearmost position out of programs having the same group identification information as that of the installed program (step S705). This is possible when the CPU 101 examines the data of the display position correspondence table together.

After acquiring the program, the CPU 101 decides whether the number of tabs in the program control screen 401 including the rearmost tab reaches a predetermined maximum number (step S706). If the number does not exceed the predetermined maximum number (NO in step S706), the CPU 101 adds a new tab for the installed program (step S707) and ends the process.

More specifically, suppose a case where a new program g having group identification information B is installed. Suppose program b is the program that has group identification information B and this tab (page position 0, tab position 1) is at the rearmost position in the programs which has group identification information B. In this case, the number of tabs of the program control screen 401 including this tab, that is, the initial program control screen 401 in FIG. 3 is 3 and the number of tabs does not reach the predetermined maximum number (e.g., 5) when the tab of program g is added, and therefore the tab of program g is added next to the tab of program b. That is, tab display becomes |a b g c|d e f|.

On the other hand, when the number of tabs reaches the predetermined maximum number instep S706 (YES instep S706), the CPU 101 decides whether the rearmost tab is the last tab in the program control screen 401 or not (step S708). If the rearmost tab is not the last tab in the screen (NO in step S708), the CPU 101 moves the last tab in the program control screen 401 to the next page (step S709) and adds a new tab for the installed program next to the rearmost tab (step S707) and ends the process.

Returning to the above specific example, if the predetermined maximum number is 3, the number of tabs of the program selection tabs 402 on the initial program control screen 401 in FIG. 4 already reaches the predetermined maximum number, and therefore it is not possible to insert any new tab into the program control screen 401. Thus, the tab of program c is moved to the next page in order to insert the tab of program g next to the tab of program b. That is, the tab display becomes |a b g|c d e|f|. Because the tab of program c has been moved to the next page, the subsequent tabs are also shifted and the tab of program f is further moved to the next page.

On the other hand, if the rearmost tab is the last tab in the program control screen 401 (YES in step S708) in step S708, the CPU 101 decides the presence/absence of programs having different group identification information before the rearmost tab in the program control screen 401 (step S710).

When there are programs having different group identification information (YES in step S710), the CPU 101 moves the tab of the program to the next page (step S711), adds a new tab for the installed program next to the rearmost tab (step S707) and ends the process.

More specifically, suppose a case where a new program h having group identification information C is installed. Furthermore, suppose the maximum number of tabs of the program selection tabs 402 in the program control screen 401 is 3. Program c is the program that has group identification information C and this tab is the last tab at page position 0. Thus, if the tab of program h is added next to this, it is placed on the next page thus nullifying the merit of its belonging to the same group. In this case, on the program control screen 401 a program having different group identification information is searched forward, and as a result, the tab of program b is moved. That is, the tab display becomes |a c h|b d e|f.

On the other hand, when there is no program having different group identification information (NO in step S710), that is, the program control screen 401 is occupied by programs having the same group identification information and if the number reaches the maximum number of tabs in the program control screen 401, the CPU 101 adds a new tab for the installed program next to the rearmost tab, that is, at the beginning of the next page (step S707) and ends the process.

Even in this case, programs belonging to the same group still exist on the neighboring page and the place is relatively close, and therefore it will not take more time and trouble for accessing both programs than when a tab of a new program is placed at the rearmost position of all programs.

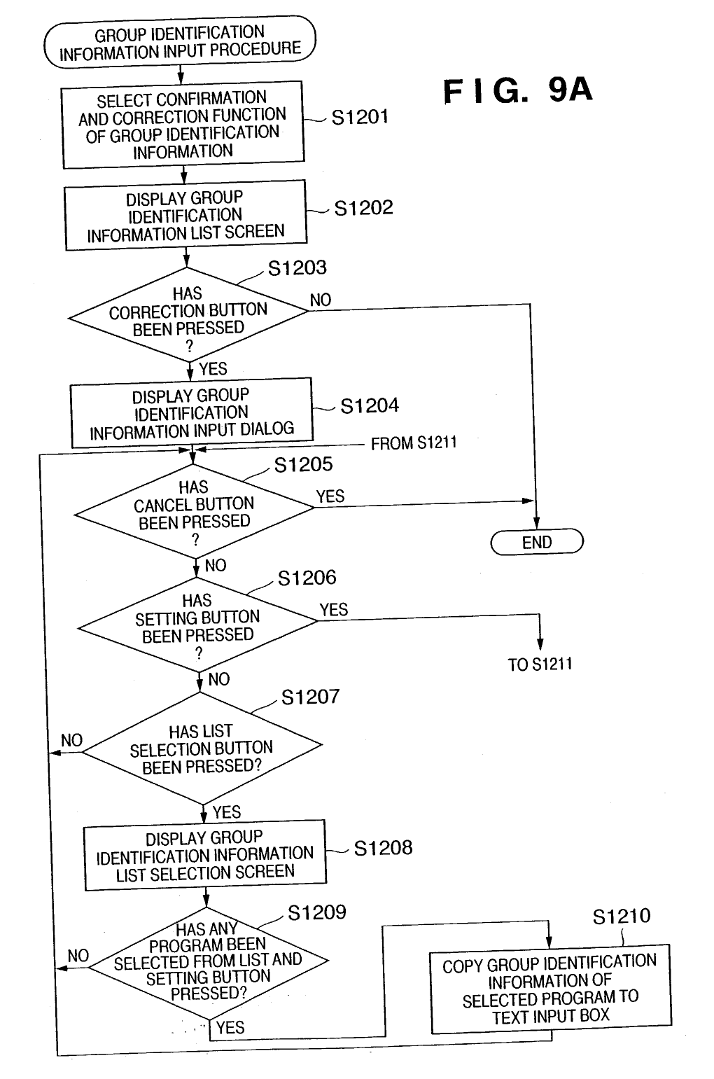

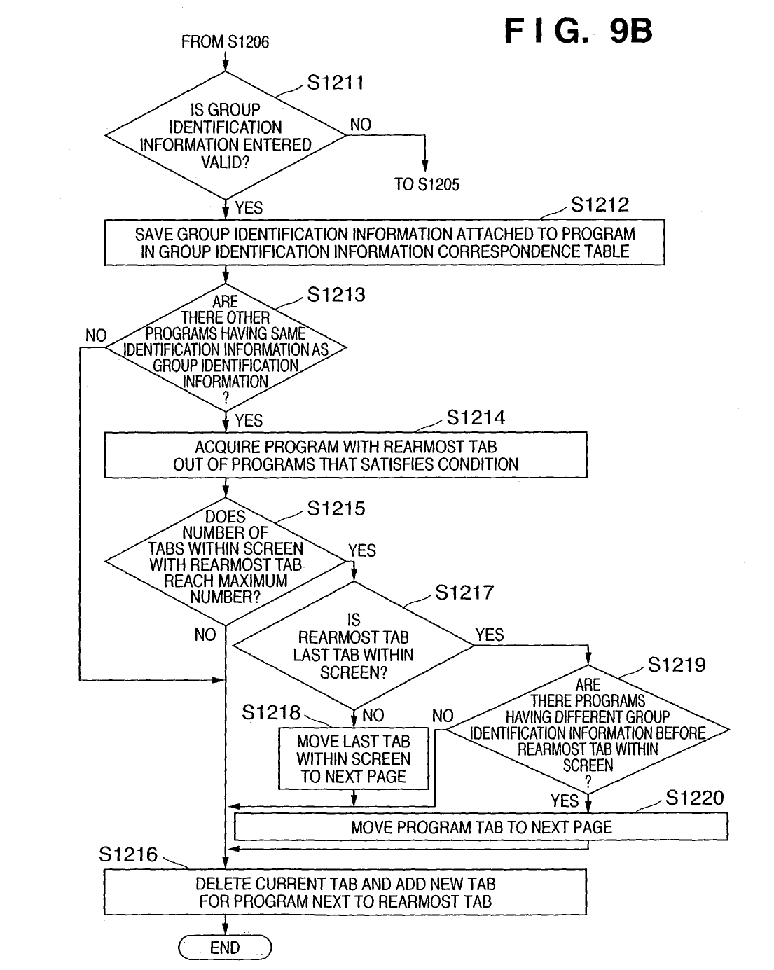

Then, operation when group identification information is input or corrected later will be explained using FIG. 9A and FIG. 9B.

FIG. 9A and FIG. 9B are flow charts showing operation when group identification information is input or corrected later by the image processing apparatus of this embodiment of the present invention.

When group identification information is input after the program is installed, the user presses the Config button 404 on the program control screen 401 and selects group identification information confirmation, correction functions from various menus (not shown) (step S1201). Through this operation, the CPU 101 shows a group identification information list screen (step S1202).

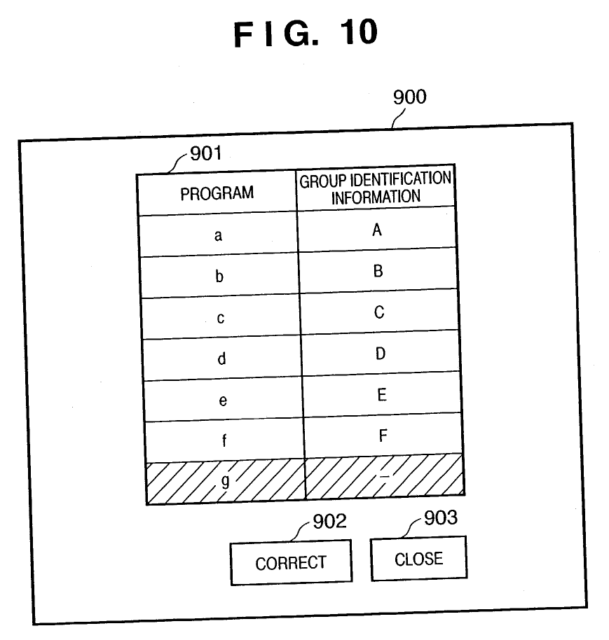

Here, a display example of the group identification information list screen is shown in FIG. 10.

On the group identification information list screen 900 in FIG. 10, reference numeral 901 is a table for controlling programs and corresponding group identification information. This reflects the data of the group identification information correspondence table in FIG. 7. Especially in FIG. 10, no group identification information is set for program g and a hyphen mark is shown to indicate that. Reference numeral 902 denotes a correction button for inputting or correcting group identification information. Reference numeral 903 denotes a button for closing this group identification information list screen 900.

Then, FIG. 9A and FIG. 9B will be explained again.

On the group identification information screen 900, the CPU 101 decides whether the correction button 902 is pressed or not (step S1203). If the correction button 902 is not pressed (NO in step S1203), that is, when the close button 903 is pressed, the CPU 101 decides that the user wants to only confirm group identification information and there is no program to be corrected and ends the process.

On the other hand, on the group identification information screen 900, if any one program is selected (in FIG. 10, program g is displayed in reverse video by touching of the screen, which indicates the program is selected) and the correction button 902 is pressed (YES in step S1203), the CPU 101 assumes that correction is selected and shows a group identification information input dialog on the display 104 (step 1204).

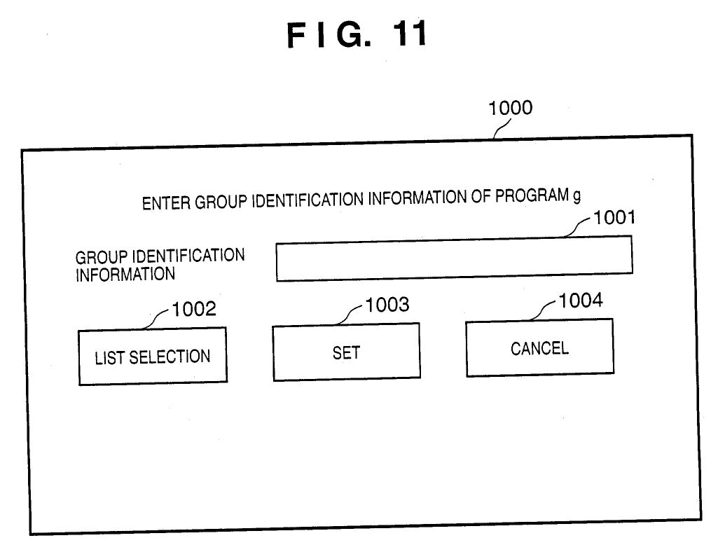

Here, a display example of the group identification information input dialog is shown in FIG. 11.

Here, since it is assumed that program g has been selected, the group identification information input dialog 1000 in FIG. 11 shows a message prompting an input “Enter group identification information of program g.”.

In FIG. 11, reference numeral 1001 denotes a text input box for inputting group identification information. Reference numeral 1002 denotes a “list selection” button for invoking a group identification information list selection screen to select and input group identification information from the group identification information list. Reference numeral 1003 denotes a setting button for setting the group identification information input to the text input box 1001 for the selected program. Reference numeral 1004 denotes a cancel button for canceling the setting.

Then, FIG. 9A and FIG. 9B will be explained again.

First, in the group identification information input dialog 1000, the CPU 101 decides whether the cancel button 1004 has been pressed or not (step S1205). If the cancel button 1004 has been pressed (YES in step 1205), the CPU 101 immediately stops the input of the group identification information and ends the process.

On the other hand, if the cancel button 1004 has not been pressed (NO in step 1205), the CPU 101 then decides whether the setting button 1003 has been pressed or not (step S1206) If the setting button 1003 has been pressed (YES in step 1206), that is, if the user enters some characters in the text input box 1001 using a key (not shown) (can be a hardware keyboard or virtual software keyboard) and then presses the setting button 1003, the process moves on to step S1211.

On the other hand, if the setting button 1003 has not been pressed (NO in step 1206), the CPU 101 decides whether the list selection button 1002 has been pressed or not (step S1207). If the list selection button 1002 has been pressed (YES in step S1207), the CPU 101 shows the group identification information list selection screen on the display 104 (step S1208). On the other hand, if the list selection button 1002 has not been pressed (NO in step S1207), the CPU 101 moves back to step S1205 and waits for an input from any one of the above-described buttons.

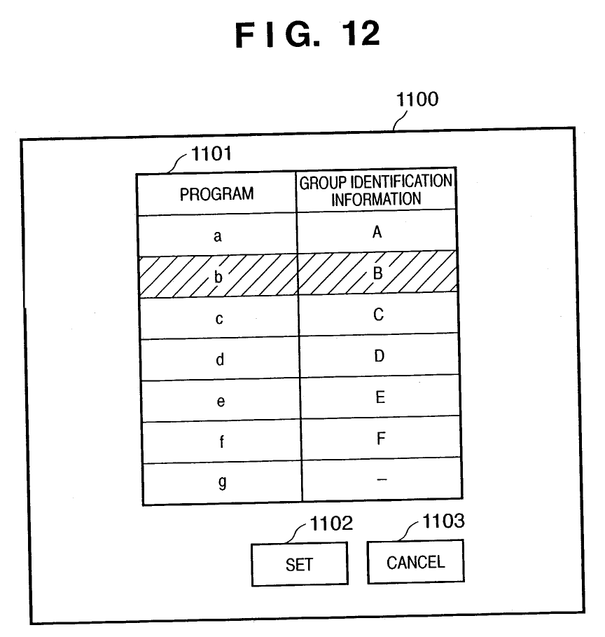

Here, a display example of the group identification information list selection screen is shown in FIG. 12.

On the group identification information list selection screen 1100 in FIG. 12, reference numeral 1101 denotes a table for controlling programs and the corresponding group identification information. This reflects the data of the group identification information correspondence table in FIG. 7. Furthermore, in FIG. 12, the row of program b is displayed in reverse video. This is because as a result of the row of program b being touched, the row is displayed in reverse video, which indicates that program b has been selected. Reference numeral 1102 denotes a setting button for copying the group identification information of the selected program to the text input box 1001. Reference numeral 1103 denotes a cancel button for canceling the setting operation.

FIG. 9A and FIG. 9B will be explained again.

Then, in the group identification information list selection screen 1100, the CPU 101 decides whether any program has been selected and whether the setting button 1102 has been pressed or not (step S1209). When the setting button 1102 has been pressed (YES in step S1209), the CPU 101 copies the group identification information of the selected program to the text input box 1001 of the group identification information input dialog 1000, ends the display of the group identification information list selection screen 1100 and moves back to the display of the group identification information input dialog 1000 (step S1210). Then, the CPU 101 moves back to step S1205 and waits for the setting button 1003 to be pressed. When the cancel button 1103 has been pressed in the group identification information list selection screen 1100 (NO in step S1209), the CPU 101 inputs nothing to the text input box 1001 and then moves back to step S1205.

As shown above, this embodiment has a configuration in such a way that group identification information can be input either by direct key input or by selecting from the group identification information selection screen.

Then, when the setting button 1003 is pressed in step S1206, the CPU 101 decides whether the input group identification information is valid or not (step S1211). In this decision, it is checked, for example, whether some characters have been entered or whether a character string input is acceptable as group identification information or not. For example, when only alphanumerics are allowed, group identification information input with kanji or kana can be regarded as invalid. When the input group identification information is not valid (NO in step S1211), the CPU 101 moves back to step S1205.

Up to this point, the input of group identification information to the program is confirmed. The remaining sequence (steps S1212 to S1215 and steps S1217 to S1220) correspond to steps S703 to S706 and steps S708 to S711 in FIG. 7 and have the same processing content, and therefore explanations thereof will be omitted. However, step S1216 has the processing content different from that of step S707 and the current tab for the program is deleted and a new tab for the program is added next to the rearmost tab. This allows the tab to be moved.

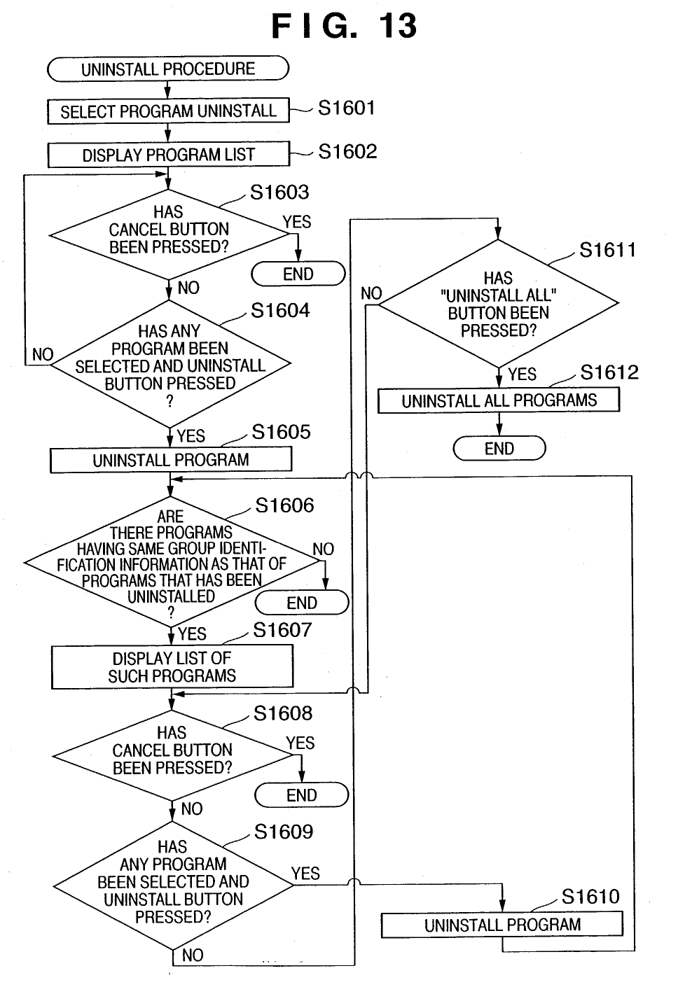

Then, the operation when uninstalling the program will be explained using FIG. 13.

FIG. 13 is a flow chart showing the operation of uninstalling a program from the image processing apparatus of this embodiment of the present invention.

First, the user selects “Uninstall program” from the menu shown by pressing the Config button 404 on the program control screen 401 (step S1601).

Thus, the CPU 101 shows a program list screen including programs to be uninstalled on the display 104 (step S1602).

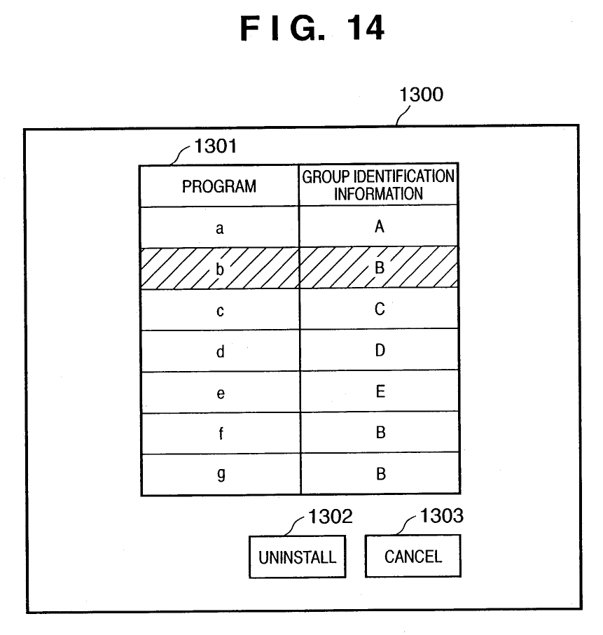

A display example of the program list screen is shown in FIG. 14 here.

On the program list screen 1300 in FIG. 14, reference numeral 1301 denotes a table for controlling programs and corresponding group identification information. This reflects the data of the group identification information correspondence table in FIG. 7. Furthermore, in FIG. 14, the row of program b is displayed in reverse video. This is because as a result of the row of program b being touched, the row is displayed in reverse video, which indicates that program b has been selected. Reference numeral 1302 denotes an uninstall button for uninstalling the selected program. Reference numeral 1303 denotes a cancel button for canceling the uninstalling operation.

FIG. 13 will be explained again.

On the program list screen 1300, the CPU 101 decides whether the cancel button 1303 has been pressed or not (step S1603). When the cancel button 1303 has been pressed (YES in S1603), the CPU 101 stops the uninstalling procedure and ends the process.

On the other hand, if the cancel button 1303 has not been pressed (NO in S1603), the CPU 101 decides whether any one program is selected and whether the uninstall button 1302 has been pressed or not (step S1604). If the uninstall button 1302 has not been pressed (NO in step S1604), the CPU 101 moves back to step S1603. On the other hand, if the uninstall button 1302 has been pressed (YES in step S1604), the CPU 101 uninstalls the selected program (step S1605).

More specifically, the CPU 101 deletes the program in question from the HD 103 or deletes the related data file or resource file from the HD 103. Furthermore, the CPU 101 deletes or updates information related to this program from the program control information. Furthermore, the CPU 101 includes the procedure for deleting the tab of the program in question in the program selection tabs 402 on the program control screen 401 or moving the tabs of other programs accordingly.

By the way, if none of the above-described buttons is pressed or if no program has been selected when the uninstall button 1302 is pressed, the CPU 101 repeats steps S1603 and step S1604.

After the program is uninstalled, the CPU 101 decides the presence/absence of programs having the same group identification information as that of the programs to be uninstalled (step S1606). If there is no program having the same group identification information (NO in step S1606), the CPU 101 ends the process.

If there are some programs having the same group identification information (YES in step S1606), the CPU 101 shows the corresponding same group program list screen on the display 104 (step S1607).

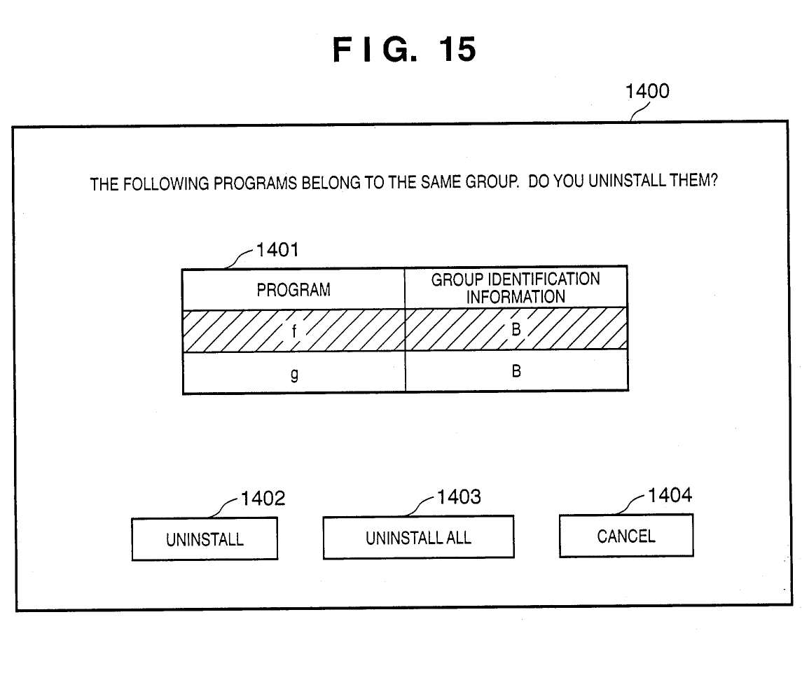

Here, a display example of the same group program list screen is shown in FIG. 15.

The same group program list screen 1400 in FIG. 15 assumes that the program b in FIG. 14 has been uninstalled. Reference numeral 1401 denotes a table for controlling the correspondence between programs having the same group identification information as that of the programs that have been uninstalled and corresponding group identification information. Here, programs f and g are assumed to have group identification information B. Since the group identification information of program b is B, programs f and g having the same group identification information B are shown. Then, a message “The following programs belong to the same group. Do you uninstall them?” is shown prompting the user to take some action.

FIG. 15 shows program f in reverse video, which indicates that it is selected. Reference numeral 1402 denotes an uninstall button to uninstall a selected program. Reference numeral 1403 denotes an “Uninstall all” button to uninstall all programs displayed in the list of the table 1401. Reference numeral 1404 denotes a cancel button to cancel the uninstall operation.

FIG. 13 will be explained again.

On the same group program list screen 1400, the CPU 101 decides whether the cancel button 1404 has been pressed or not (step S1608). If the cancel button 1404 has been pressed (YES in step S1608), the CPU 101 stops uninstalling and ends the process.

On the other hand, if the cancel button 1404 has not been pressed (NO in step S1608), the CPU 101 decides which program has been selected and whether the uninstall button 1402 has been pressed or not (step S1609). If the uninstall button 1402 has been pressed (YES in step S1609), the CPU 101 uninstalls the selected programs (step S1610). Then, the CPU 101 moves back to step S1606. Thus, it is also possible to uninstall the remaining programs. That is, the user can select individual/batch uninstall of programs on the same group program list screen.

On the other hand, if the uninstall button 1402 has not been pressed (NO in step S1609), the CPU 101 decides whether the uninstall all button 1403 has been pressed or not (step S1611). If the uninstall all button 1403 has been pressed (YES in step S1611), the CPU 101 uninstalls all programs in the table 1401 of the same group program list screen 1400 (step S1612) and ends the process.

On the other hand, if the uninstall all button 1403 has not been pressed (NO in step S1611), the CPU 101 moves back to step S1608 and waits for any button to be pressed.

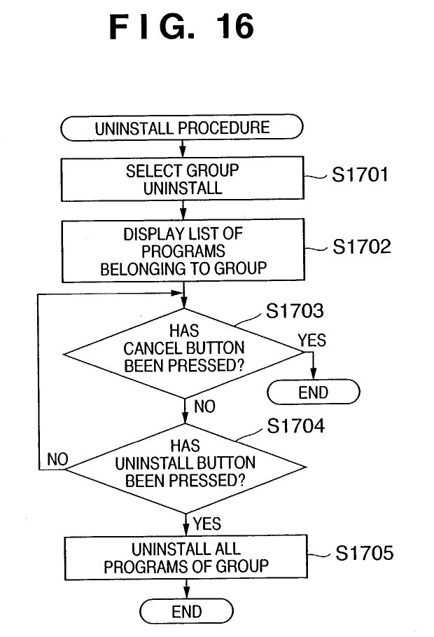

Then, the operation of uninstalling programs by specifying a group will be explained using FIG. 16.

FIG. 16 is a flow chart showing the operation of uninstalling programs by specifying a group from the image processing apparatus of this embodiment of the present invention.

First, the user selects “Uninstall program by specifying group” from the menu shown by pressing the Config button 404 on the program control screen 401 (step S1701). Though not shown in the figure, the user also enters group identification information to indicate which group is to be uninstalled.

In response to this, the CPU 101 shows a specified group program list screen made up of a list of programs belonging to the specified group on the display 104 (step S1702).

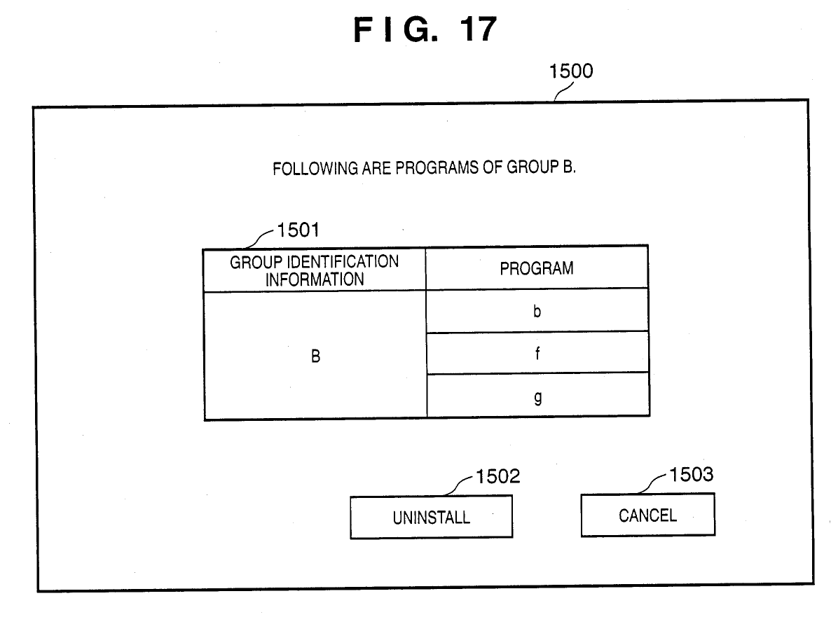

Here, a display example of the specified group program list screen is shown in FIG. 17.

The specified group program list screen 1500 in FIG. 17 supposes that a group of group identification information B has been specified. Reference numeral 1501 denotes a table showing a list of programs having group identification information B. This table is obtained by searching for the program having group identification information B from the group identification information correspondence table in FIG. 7. Reference numeral 1502 denotes an uninstall button to uninstall all programs in the group. Reference numeral 1503 denotes a cancel button to cancel the uninstall operation.

FIG. 16 will be explained again.

On the specified group program list screen 1500, the CPU 101 decides whether the cancel button 1503 has been pressed or not (step S1703). When the cancel button 1503 has been pressed (YES in S1703), the CPU 101 stops the uninstalling procedure and ends the process.

On the other hand, if the cancel button 1503 has not been pressed (NO in S1703), the CPU 101 decides whether the uninstall button 1502 has been pressed or not (step S1704). If the uninstall button 1502 has not been pressed (NO in step S1704), the CPU 101 moves back to step S1703. On the other hand, if the uninstall button 1502 has been pressed (YES in step S1704), the CPU 101 uninstalls all programs displayed, that is, programs b, f and g of group identification information B here (step S1705) and ends the process.

As explained above, according to this embodiment, when grouped programs are installed, the program selecting means (tabs in this embodiment) can make the program selection operation easy to understand and simple in such a way that grouped programs are placed close to one another.

Furthermore, this embodiment can further simplify the program selection operation by controlling the display in such a way that the program selecting means of programs to be installed and the program selecting means of programs having the same group identification information are placed within the same program control screen.

Furthermore, when program selecting means of programs to be installed are placed within the program control screen, if the maximum number of program selecting means to be placed within the program control screen is exceeded, this embodiment selects at least one of the program selecting means within the program control screen except the program selecting means of programs to be installed and the program selecting means of programs having the same group identification information as that of the programs to be installed and controls the display so that the selected program selecting means are moved to the program control screen on another page, and can thereby place as many program selecting means belonging to the same group as possible within the same program control screen.

Furthermore, even in the case of a program having no group identification information at the time of installation or a program having invalid group identification information, it is possible to group the programs by inputting group identification information and thereby change the display position of the program selecting means on the program control screen after installation.

Furthermore, when group identification information associated with programs is input, this embodiment makes it possible to decide group identification information to be input while referencing the group identification information of existing programs and thereby allow the user to enter group identification information without hesitation.

Furthermore, when programs are uninstalled, this embodiment uninstalls grouped programs all together, making it possible to save time and trouble of having to uninstall programs individually and thereby prevent misoperation involved in the individual uninstall operations.

Furthermore, this embodiment allows the user to uninstall programs having the same group identification information while checking individual programs. This allows flexible grouping and uninstalling and makes it possible to lift restrictions that all programs belonging to the same group should necessarily be uninstalled.

Furthermore, this embodiment displays information on the correspondence between programs and their group identification information, and can thereby always check the correspondence between programs and their group identification information.

So far, this embodiment of the present invention has been explained based on the drawings, but the present invention is not limited to these cases and is also applicable to a variety of cases.

For example, the case where tabs are used as the program selecting means have been explained above, but the present invention is also applicable to a case where buttons or icons are used instead.

Moreover, though the present invention requires hardware, the present invention can be implemented by a program operating on each apparatus. Thus, the above-described functions can be implemented by reading and executing programs and program codes of software that implements the functions of the above-described embodiment from storage media that store the programs and program codes.

The present invention is also applicable to cases where programs of software that implements the functions of the above-described embodiment (program corresponding to the flow charts shown in the figures in the embodiment) are supplied to a system or apparatus directly or from a remote place and a computer of the system or apparatus reads and executes the program codes supplied. In that case, the mode is not limited to a program if it has at least functions of a program.

Thus, program codes installed in the computer to realize the function and processing of the present invention by the computer also implement the present invention. That is, the present invention also includes a computer program itself which realizes function and processing of the present invention.

In that case, the program mode does not matter, whether it is object code, program executed by an interpreter, script data supplied to the OS, etc., if it has at least functions of a program.

Examples of storage media to supply programs include a floppy (registered trademark) disk, hard disk, optical disk, magneto-optical disk, CD-ROM, CD-R, CD-RW, magnetic tape, non-volatile memory card, ROM, DVD (DVD-ROM, DVDR), etc.

In addition, there is another method of supplying programs by connecting to an Internet web page using a browser of a client computer and downloading the computer program of the present invention from the web page or downloading a file including a compressed automatic install function to a storage medium such as a hard disk. Furthermore, programs can also be supplied by dividing a program code making up the program of the present invention into a plurality of files and downloading the respective files from different web pages. That is, a WWW server which allows a plurality of users to download programs files to realize functions and processing of the present invention by a computer is also included in the present invention.

Furthermore, it is also possible to implement the present invention by encrypting the program of the present invention, storing it in a storage medium such as CD-ROM, distributing the CD-ROM to users, allowing users who have cleared predetermined conditions to download key information to decrypt the encrypted program from a web page through the Internet, install and execute the encrypted program using the key information on a computer.

Furthermore, it is also possible to implement the functions of the above-described embodiment by executing the program read by a computer or by allowing the OS operating on a computer to execute part or all actual processing based on instructions of the program.

Furthermore, it is also possible to implement the functions of the above-described embodiment by executing part or all actual processing based on instructions of the program with a CPU provided for a function expansion board or a function extension unit after the program read from a storage medium is written to a memory provided for a function expansion board inserted in a computer or a function extension unit connected to a computer.

(Second Embodiment)

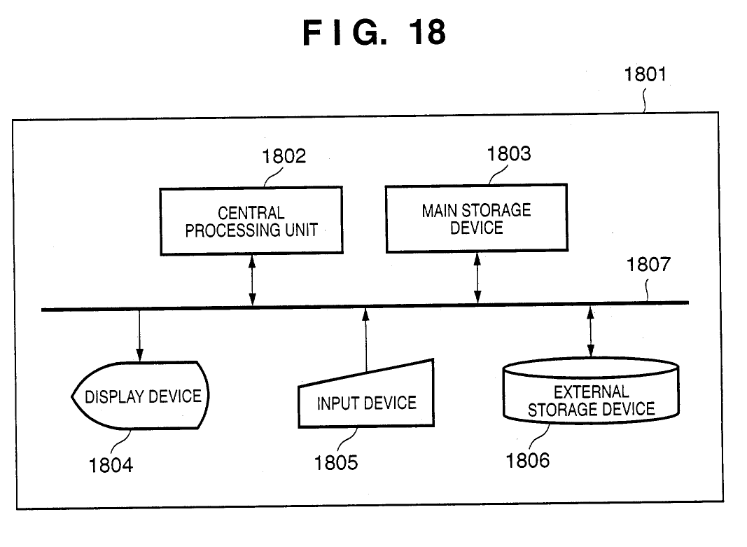

A second embodiment of the present invention will be explained with reference to FIG. 18 to FIG. 26.

FIG. 18 is a block diagram showing a functional configuration of an image processing apparatus of a second embodiment of the present invention. In the same figure, reference numeral 1801 denotes an image processing apparatus allowing image scanning or image printout such as a copier, printer or FAX, which incorporates a control program (hereinafter, such a control program will be referred to as “program manager”) to realize a control method according to the second embodiment of the present invention.

Reference numeral 1802 denotes a central processing unit (CPU) made up of a microprocessor, etc., for executing various types of processing which will be described later.

Reference numeral 1803 denotes a main storage device made up of a RAM, etc., and this main storage device 1803 is used to store and execute an operating system (OS) and program read from an external storage device 1806.

Reference numeral 1804 denotes a display device such as a touch display and is used to display the status of a program in execution.

Reference numeral 1805 denotes an input device for the user to enter instructions.

Reference numeral 1806 denotes an external storage device in the image processing apparatus 1801, which is provided with a storage medium such as a hard disk, magneto-optical disk, PC card memory and flash memory, and used to store an operating system (OS) and various application programs (hereinafter simply referred to as “programs”).

Reference numeral 1807 denotes a bus and is used to exchange data and signals between the above-described components in the image processing apparatus 1801.

In the image processing apparatus 1801 incorporating the program manager in the above-described configuration, the central processing unit 1802 starts to execute a program manager or program read into the main storage device 1803. Information such as starting conditions of programs started by the program manager is stored in the external storage device 1806. Furthermore, the progress of the program in execution is displayed on the display device 1804 and the input device 1805 can input data necessary for operation of the program manager and program itself.

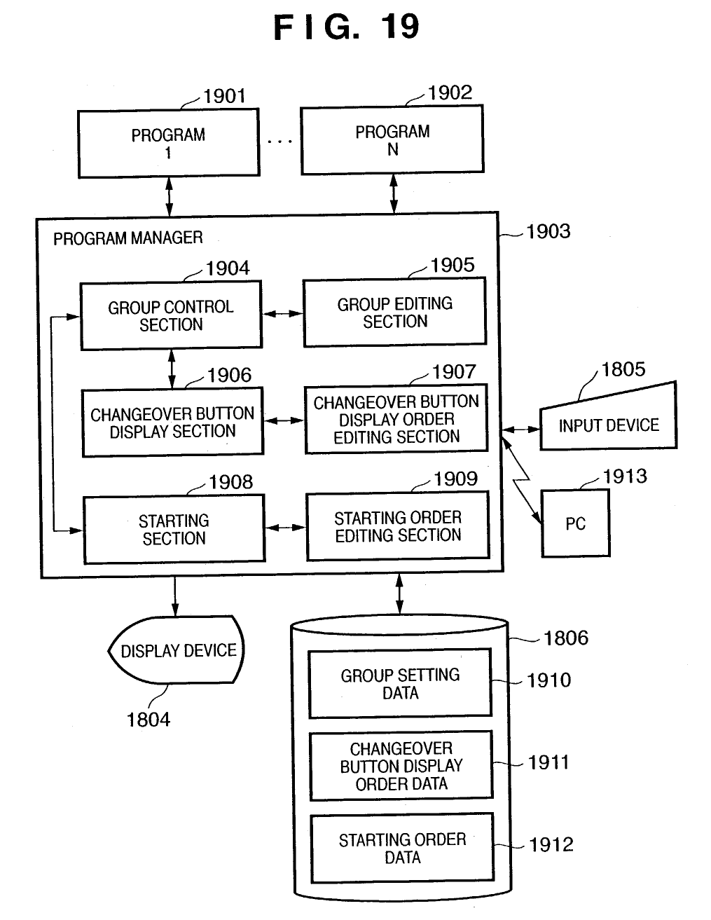

FIG. 19 is a basic block diagram showing the control function of the program manager in the image processing apparatus. In the same figure, reference numeral 1901 denotes program 1 which is started by the program manager 1903.

Reference numeral 1902 denotes program N which is started by the program manager 1903.

Reference numeral 1903 denotes a program manager according to the second embodiment of the present invention and controls starting, stopping the programs 1901 and 1902 or switching between screens of programs in execution.

Reference numeral 1904 denotes a group control section, which controls program groups based on group setting data 1910 stored in the external storage device 1806.

Reference numeral 1905 denotes a group editing section, which edits the group setting data 1910 stored in the external storage device 1806 based on instructions from the input device 1805.

Reference numeral 1906 denotes a changeover button display section, which displays program changeover buttons (buttons to switch between screens of a plurality of started programs) in order of changeover button display order data 1911 stored in the external storage device 1806.

Reference numeral 1907 denotes a changeover button display order editing section, which edits the changeover button display order data 1911 stored in the external storage device 1806 based on instructions from the input device 1805.

Reference numeral 1908 denotes a starting section, which starts programs in starting order data 1912 stored in the external storage device 1806.

Reference numeral 1909 denotes a starting order editing section, which edits the starting order data 1912 stored in the external storage device 1806 based on instructions from the input device 1805.

Reference numeral 1910 denotes group setting data, which registers one or more programs as a group and defines a plurality of groups as a list based on instructions from the input device 1805.

Reference numeral 1911 denotes changeover button display order data, which defines the order in which program changeover buttons are displayed by the changeover button display section 1906 in group units.

Reference numeral 1912 denotes starting order data, which defines the order in which programs are started by the starting section 1908 in group units.

Reference numeral 1913 denotes a PC, which is connected to the image processing apparatus 1801 incorporating the program manager according to the second embodiment of the present invention, capable of editing the group setting data 1910, changeover button display order data 1911 and starting order data 1912 from the outside.

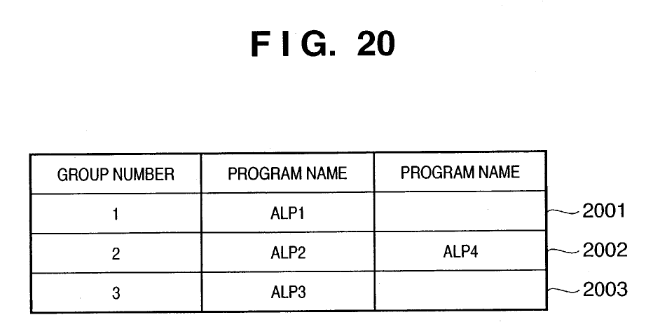

FIG. 20 shows an example of contents of the group setting data 1910. In the same figure, reference numeral 2001 denotes a list of program names registered in group number 1 and in this example, one program called “APL1” is registered.

Reference numeral 2002 denotes a list of program names registered in group number 2 and in this example, two programs called “APL2” and “APL4” are registered (in this embodiment, when a plurality of programs are registered in the same group, programs in the same group are displayed from left to right.

Reference numeral 2003 denotes a list of program names registered in group number 3 and in this example, one program called “APL3” is registered.

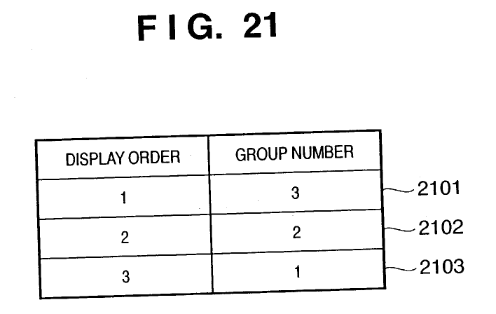

FIG. 21 shows an example of contents of the changeover button display order data 1911. In the same figure, reference numeral 2101 denotes a group number registered in display order 1 and in this example, group number “3” is registered.

Reference numeral 2102 denotes a group number registered in display order 2 and in this example, group number “2” is registered.

Reference numeral 2103 denotes a group number registered in display order 3 and in this example, group number “1” is registered.

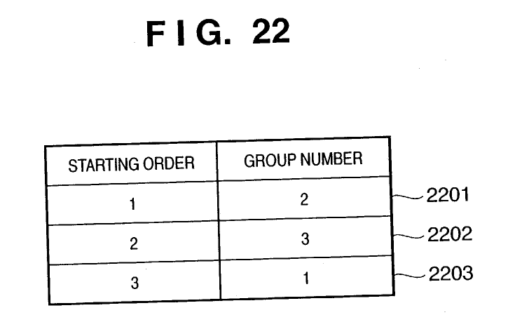

FIG. 22 shows an example of contents of the starting order data 1912. In the same figure, reference numeral 2201 denotes a group number registered in starting order 1 and in this example, group number “2” is registered.

Reference numeral 2202 denotes a group number registered in starting order 2 and in this example, group number “3” is registered.

Reference numeral 2203 denotes a group number registered in starting order 3 and in this example, group number “1” is registered.

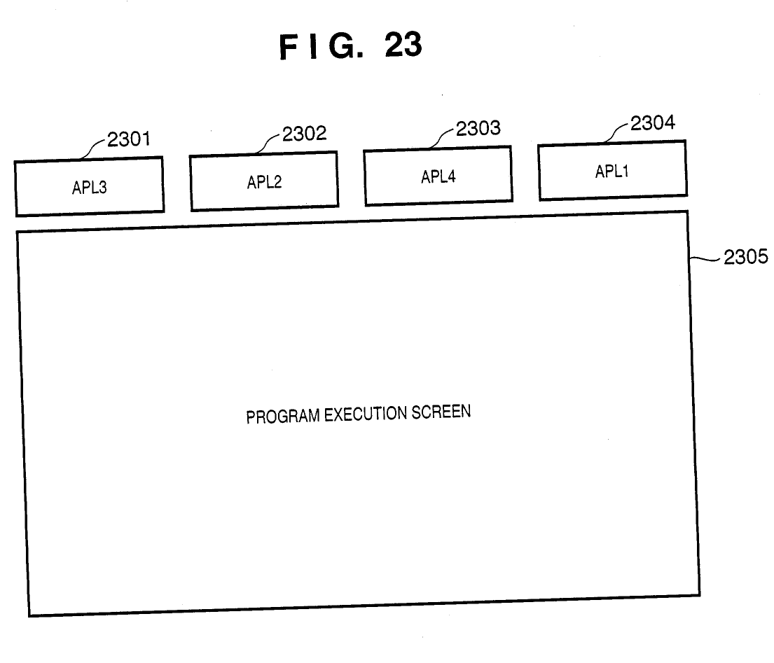

FIG. 23 shows an example of a screen when the program manager according to the second embodiment of the present invention starts the programs APL1 to APL4 and shows their respective program changeover buttons based on the data in FIG. 20 to FIG. 22. In the same figure, reference numeral 2301 denotes a changeover button of the program name APL3 and reference numerals 2302 to 2304 denote changeover buttons of the program names APL2, 4 and 1, respectively.

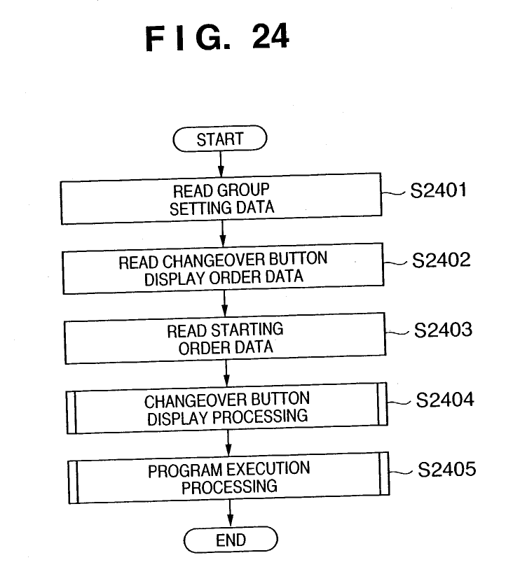

FIG. 24 is a flow chart showing program starting processing and program changeover button display processing by the program manager. The program code of this processing program is stored in the main storage device 1803 and when the central processing unit 1802 executes this program code, various sections such as the group control section 1904, group editing section 1905, changeover button display section 1906, changeover button display order editing section 1907, starting section 1908 and starting order editing section 1909 function.

This program code corresponds to the control procedure after the program manager of this embodiment reads the group setting data 1910, changeover button display order data 1911 and starting order data 1912 stored in the external storage device 1806, displays the changeover buttons in the program changeover button display order until the program manager starts the programs in the program execution order.

In this embodiment, in FIG. 24, the group setting data 1910 stored in the external storage device 1806 is read into the main storage device 1803 (step S2401), and then the changeover button display order data 1911 stored in the external storage device 1806 is read into the main storage device 1803 (step S2402). Furthermore, the starting order data 1912 stored in the external storage device 1806 is read into the main storage device 1803 (STEP S2403). After above-described three definition data; the group setting data 1910, changeover button display order data 1911 and starting order data 1912 are read, the program manager carries out display processing of the changeover buttons (step S2404) and executes the programs (step S2405).

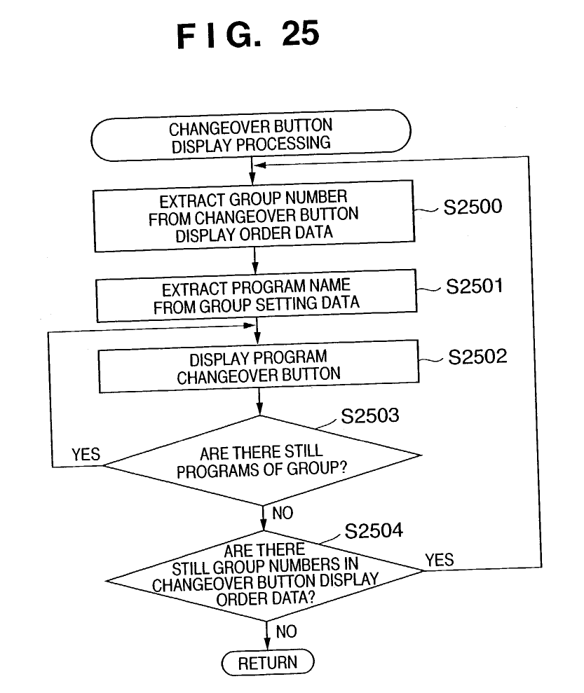

FIG. 25 is a flow chart showing a control processing procedure of the display processing of the program changeover buttons by the program manager.

This program code corresponds to the control procedure until the program manager of this embodiment displays the program changeover buttons based on the group setting data 1910 and changeover button display order data 1911.

According to this embodiment, in FIG. 25, a group number is extracted from the changeover button display order data 1911 (step S2500) and a program name that belongs to the group number is extracted from the group setting data 1910 (step S2501). Then, the changeover button of the extracted program is displayed (step S2502) and it is decided whether there are still programs belonging to the group or not (step S2503). When it is decided in step S2503 that there are still programs belonging to the group, the process moves back to step S2502 and moves back to the step of displaying the changeover button of the next program. When it is decided in step S2503 that there is no more program belonging to the group, it is decided whether there are remaining group numbers in the changeover button display order data 1911 (step S2504) and if there are remaining group numbers, the process moves back to step S2501 and moves back to the step of extracting the next group number. When it is decided in step S2504 that there is no more remaining group number, the process exits the step of displaying the changeover buttons.

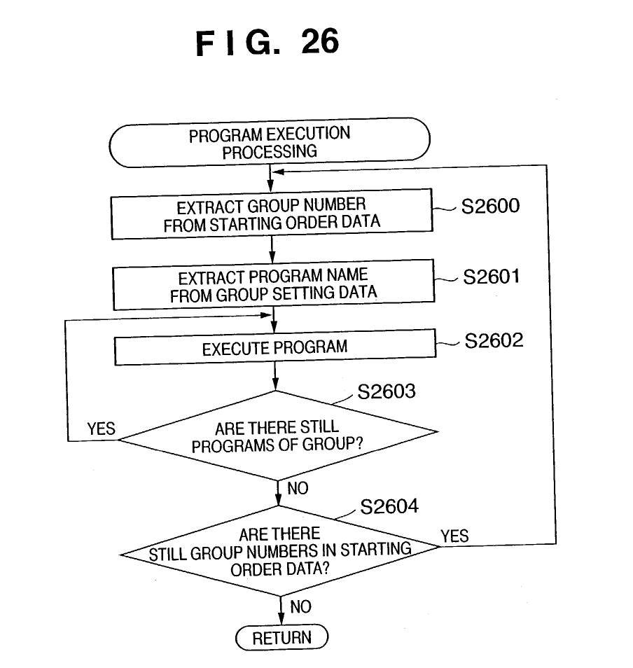

FIG. 26 is a flow chart showing the control processing procedure of program execution processing by the program manager.

This program code corresponds to the control procedure until the program manager of this embodiment executes the program based on the group setting data 1910 and starting order data 1912.

According to this embodiment, as shown in FIG. 26, a group number is extracted from the starting order data 1912 (step S2600) and a program name belonging to the group number is extracted from the group setting data 1910 (step S2601). Then, the extracted program is executed (step S2602) and it is decided whether there are still any programs belonging to the group or not (step S2603). If it is decided in step S2603 that there are still programs belonging to the group, the process moves back to step S2602 and moves back to the step of executing the next program. If it is decided in step S2603 that there is no more program belonging to the group, it is decided whether there are any remaining group numbers in the starting order data 1912 (step S2604), and if there are remaining group numbers, the process moves back to step S2600 and moves back to the step of extracting the next group number. If it is decided in step S2604 that there is no more remaining group number, the process exits the step of executing the program.

As explained above, the program manager of this embodiment provides the function of setting the program changeover button display order and the function of setting the program starting order to the user and the program manager also displays the changeover buttons and starts the programs based on those settings, and can thereby flexibly respond to the user's demands by displaying the changeover buttons and icons of frequently used programs in preferential order specified by the user, and thereby has the effect of improving convenience for the user.

Furthermore, because of the inclusion of the group control section that controls programs divided into a predetermined number of groups it is only necessary to set the display order or starting order corresponding in number to groups, thus having the effect of reducing the user's operation load.

Furthermore, it is possible to define one or more programs in the group setting data for individual groups controlled by the group control section, having the effect of handling groups for which only one group is defined and groups for which a plurality of groups are defined in a unified manner.

Furthermore, this embodiment displays groups controlled by the group control section according to the display order defined in the changeover button display order data, and can thereby preferentially display frequently used programs ahead of others, thus having the effect of improving the user's operability.

Furthermore, the changeover button display order data defines the display order in units of groups controlled by the group control section, and can thereby display programs to be processed linked to each other side by side, thus having the effect of improving the user's operability.

Furthermore, the starting section starts groups controlled by the group control section according to the starting order defined in the starting order data, thus having the effect of making the control of programs dependent on the starting order easier.

Furthermore, the starting order data defines the starting order in units of groups controlled by the group control section, thus having the effect of being able to start programs to be processed linked with each other all at once.

Furthermore, the changeover button display section can also be displayed not only in the form of changeover buttons but also in other forms such as program icons or changeover tabs, thus having the effect of being able to flexibly adopt forms easy to operate for the user.

(Third Embodiment)

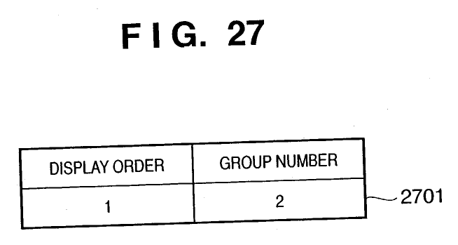

The second embodiment above has described an example of the case where all groups are defined in the changeover button display order data and the program changeover buttons are displayed in the display order, but it is possible to realize the function of the program manager even if only some groups are defined in the changeover button display order data. Hereunder, a third embodiment of the present invention will be explained with reference to FIG. 27 to FIG. 30.

FIG. 27 shows an example of showing contents of the changeover button display order data 1911 when only one group is registered. In the same figure, reference numeral 2701 denotes a group number registered in display order 1 and group number 2 is registered in this example.

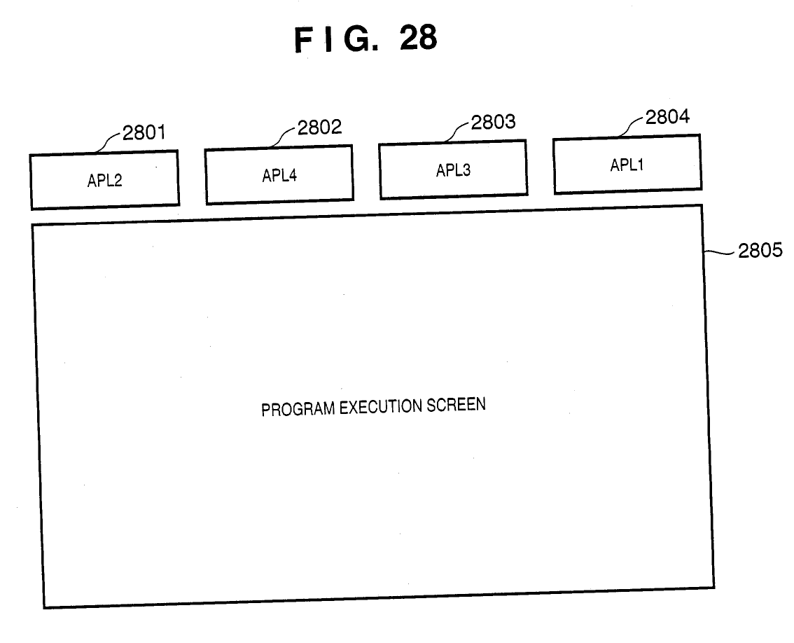

FIG. 28 shows an example of a screen when the program manager according to the third embodiment of the present invention starts programs APL1 to APL4 based on the data in FIG. 22 and FIG. 27 and displays their program changeover buttons. In the same figure, reference numeral 2801 denotes a changeover button of the program name APL2. Reference numerals 2802 to 2804 denote changeover buttons of the program names APL4, 3 and 1 respectively.

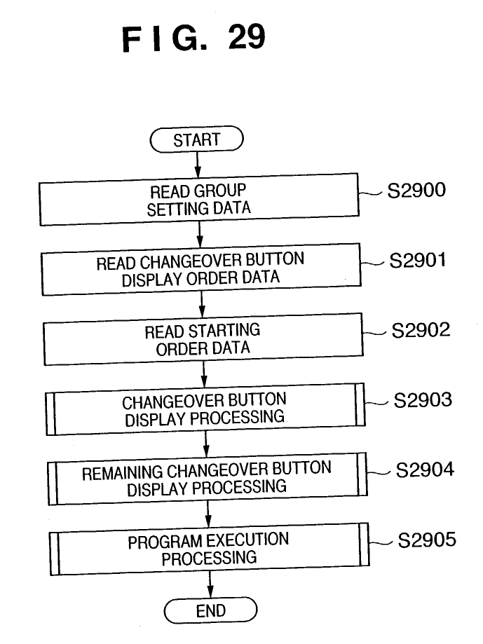

FIG. 29 is a flow chart indicating the control processing procedure of the program manager when only some groups are defined in the changeover button display order data.

This program code corresponds to the control procedure after the program manager of this embodiment reads the group setting data 1910, changeover button display order data 1911 and starting order data 1912 stored in the external storage device 1806, displays the changeover buttons according to the program changeover button display order, displays the changeover buttons according to the program execution order for the groups whose changeover button display order is not specified until the program manager starts programs according to the program execution order.

According to this embodiment, as shown in FIG. 29, the group setting data 1910 stored in the external storage device 1806 is read into the main storage device 1803 (step S2900), then the changeover button display order data 1911 stored in the external storage device 1806 is read into the main storage device 1803 (step S2901). Furthermore, the starting order data 1912 stored in the external storage device 1806 is read into the main storage device 1803 (step S2902). After the above-described three definition data; the group setting data 1910, changeover button display order data 1911 and starting order data 1912 are read, the program manager carries out display processing of only the changeover buttons corresponding in number to groups defined in the changeover button display order data 1911 (step S2903), then displays the changeover buttons of the remaining groups not defined in the changeover button display order data 1911 (step S2904). Then, the program manager carries out execution processing on the programs (step S2905).

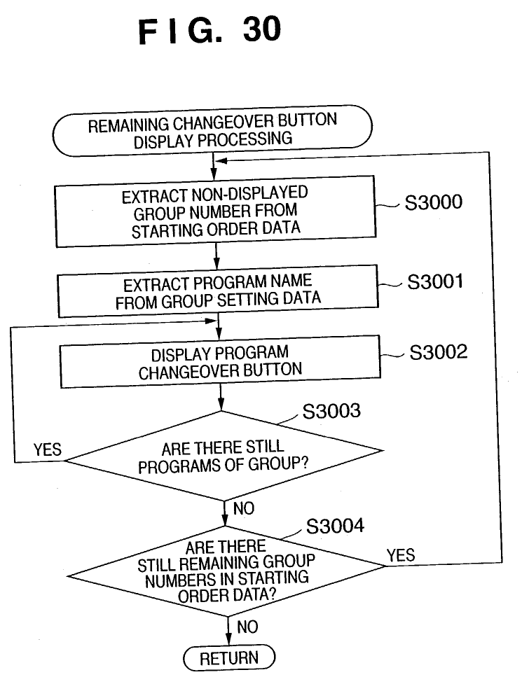

FIG. 30 is a flow chart showing a control processing procedure of the process of displaying the changeover buttons of the remaining groups not defined in the changeover button display order data.

This program code corresponds to the control procedure until the program manager of this embodiment displays the program changeover buttons based on the group setting data 1910 and starting order data 1912.

According to this embodiment, in FIG. 30, a group number whose group changeover button is not displayed yet is extracted from the starting order data 1912 (step S3000) and a program name that belongs to the group number is extracted from the group setting data 1910 (step S3001) Then, the changeover button of the extracted program is displayed (step S3002) and it is decided whether there are still programs belonging to the group or not (step S3003) When it is decided in step S3003 that there are still programs belonging to the group, the process moves back to step S3002 and moves back to the step of displaying the changeover button of the next program. When it is decided in step S3003 that there is no more program belonging to the group, it is decided whether there are remaining group numbers in the starting order data 1912 (step S3004) and if there are remaining group numbers, the process moves back to step S3000 and moves back to the step of extracting the next group number. When it is decided in step S3004 that there is no more remaining group number, the process exits the step of displaying the remaining changeover buttons.

Here, the process of displaying the changeover buttons in step S2903 and the program executing process in step S2905 in FIG. 29 carry out the same processes as the process of displaying the changeover buttons in step S2404 and the program executing process in step S2405 in the flow chart in FIG. 24, and therefore explanations thereof will be omitted here.

As described above, the program manager of the third embodiment provides the user with the function of setting grouping of programs, function of setting the program changeover button display order and function of setting the program starting order and even if only some groups are defined in the changeover button display order data at that time, the program manager can display changeover buttons of all programs and start the programs, and therefore the user only needs to register groups to be preferentially displayed, thus having the effect of saving time and trouble of having to register all groups.

In the above-described embodiments, the program code groups shown in FIG. 24 to FIG. 26, FIG. 29 and FIG. 30 are stored in the main storage device 1803, but it is also possible to adapt the present invention so that the storage medium of the external storage device 1806 or internal storage resource stores the program code groups shown in FIG. 24 to FIG. 26, FIG. 29 and FIG. 30 and the central processing unit (CPU) 1802 reads and executes program codes from this storage medium.

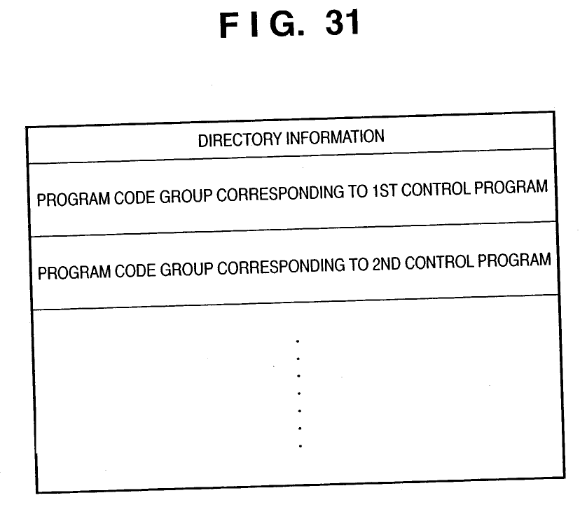

FIG. 31 denotes a memory map of the storage medium that stores program code groups of various CPU-readable control programs. This storage medium stores the program codes shown in the flow charts in FIG. 24 to FIG. 26, that is, the program codes according to the second embodiment as the program code group corresponding to the first control program. The storage medium also stores the program codes according to the third embodiment as the program code group corresponding to the second control program.

Though not particularly shown in the figure, this storage medium can also be adapted so as to store information for controlling program groups to be stored, for example, version information and author, and information dependent on the OS on the program reading side, etc., and store, for example, icons for identifying and displaying programs, etc.

Furthermore, data dependent on various programs is also stored in the above-described storage medium. Furthermore, when programs for installing various programs in a computer or programs to be installed are compressed, it is also possible to store a decompressing program, etc.

Furthermore, it is also possible for this system to execute the functions of the program code groups shown in FIG. 31 according to a program installed from the outside. In this case, it is also possible to supply an information group including programs from a storage medium such as CD-ROM, flash memory and FD or from an external storage medium through a network to this system.

Thus, the objects of the present invention can also be attained by supplying a storage medium that records program codes of software for realizing the functions of this embodiment to the system or apparatus and by a computer (CPU or MMU) of the system or apparatus reading and executing the program codes stored in the storage medium.

In this case, the program codes read from the storage medium themselves realize the new functions of the present invention, and therefore the storage medium that stores the program codes constitutes the present invention.

Examples of storage media to supply program codes include a floppy (registered trademark) disk, hard disk, optical disk, magneto-optical disk, DVD, CD-ROM, CD-R, magnetic tape, non-volatile memory card, ROM, EEPROM, etc.

Furthermore, not only the case where the functions of the above-described embodiment are realized when the computer executes the read program codes but also the case where the operating system, etc., operating on a computer performs part or all of the actual processing based on instructions of the program codes and the functions of the above-described embodiment are realized through the processing is included the present invention.

Furthermore, the present invention also includes a case where after program codes read from a storage medium are written into a memory provided for a functional extension board inserted in a computer or a functional extension unit connected to a computer, a CPU, etc., provided for the functional extension board or the functional extension unit carries out part or all of actual processing and the functions of the above-described embodiment are realized through the processing based on instructions of the program codes.

Furthermore, the present invention may also be applicable to a system made up of a plurality of devices or an apparatus made up of a single device. Furthermore, the effects of the present invention can be achieved by a system or apparatus downloading and reading the program expressed by the software for achieving the present invention from a database on a network through a communication program.

As explained above, the present invention can improve operability with respect to installing/uninstalling of programs and execute installing/uninstalling safely.

Furthermore, the present invention makes it possible to flexibly change both the display order on a screen of changeover buttons for changing screens of started programs and program starting order.

As a result, it is possible to improve operability of the image processing apparatus.

The present invention is not limited to the above embodiments and various changes and modifications can be made within the spirit and scope of the present invention. Therefore to apprise the public of the scope of the present invention, the following claims are made.

What is claimed is:

1. An image processing apparatus that controls a plurality of programs, comprising:
first storage means for storing a group identification information correspondence table that controls the correspondence between a program and group identification information indicating a group to which the program belongs;
second storage means for storing a display position correspondence table that controls the correspondence between a program and a display position of the corresponding program selection means;
installing means for installing programs to be installed;
decision means for referencing said group identification information correspondence table and deciding the presence/absence of other programs having the same group identification information as the group identification information of said programs to be installed; and
display control means for controlling, when said decision means decides that said other programs exist, the display of the program selection means of said programs to be installed based on the display positions of the program selection means of said other programs controlled in said display position correspondence table.

2. The image processing apparatus according to claim 1, wherein said display control means controls the display of the program selection means of said programs to be installed so that the program selection means of said other programs are arranged within the same displayed screen.

3. The image processing apparatus according to claim 1, wherein said display control means arranges the program selection means of said programs to be installed within a screen and thereby controls the display, when the number of the program selection means exceeds a maximum number of program selection means to be arranged within said screen, in such a way that at least one of the program selection means within said screen other than the respective program selection means of said programs to be installed and said other programs is moved to other screen.

4. An image processing apparatus that controls a plurality of programs, comprising:
first storage means for storing a group identification information correspondence table that controls the correspondence between a program and group identification information indicating a group to which the program belongs;
second storage means for storing a display position correspondence table that controls the correspondence between a program and a display position of the corresponding program selection means;
input means for inputting group identification information corresponding to programs to be processed;
decision means for referencing said group identification information correspondence table and deciding the presence/absence of other programs having the same group identification information as the group identification information of said programs to be processed; and
display control means for controlling, when said decision means decides that said other programs exist, the display of the program selection means of said programs to be processed based on the display positions of the program selection means of said other programs controlled by said display position correspondence table.

5. The image processing apparatus according to claim 4, wherein said input means comprising:
display means for displaying a list of group identification information of programs already installed;
selection means for selecting desired group identification information from the list of group identification information displayed on said display means; and
setting means for setting the group identification information selected by said selection means for said programs to be processed.

6. An image processing apparatus for controlling a plurality of programs, comprising:
storage means for storing a group identification information correspondence table that controls the correspondence between a program and group identification information indicating a group to which the program belongs;
specification means for specifying programs to be uninstalled;
first uninstalling means for uninstalling the programs to be uninstalled specified by said specification means;
decision means for referencing said group identification information correspondence table and deciding the presence/absence of other programs having the same group identification information as the group identification information of said programs to be uninstalled; and
second uninstalling means for uninstalling said other programs when said decision means decides that said other programs exist.

7. The image processing apparatus according to claim 6, wherein second uninstalling means comprising:
display means for displaying said other programs; and
instruction means for instructing execution of individual/batch uninstalling of said other programs displayed by said display means.

8. An image processing apparatus that controls a plurality of programs, comprising:
storage means for storing a group identification information correspondence table that controls the correspondence between a program and group identification information indicating a group to which the program belongs;
input means for inputting group identification information;
display means for referencing said group identification information correspondence table and displaying a program having the group identification information input by said input means; and
instruction means for instructing uninstalling of all said programs displayed by said display means.

9. A control method for controlling a plurality of programs, comprising:
an installing step of installing programs to be installed;
a deciding step of referencing a group identification information correspondence table that controls the correspondence between a program and group identification information indicating the group to which the program belongs and deciding the presence/absence of other programs having the same group identification information as the group identification information of said programs to be installed; and
display controlling step of controlling, when it is decided in said deciding step that said other programs exist, the display of the program selection means of said programs to be installed based on the display positions of the program selection means of said other programs controlled by display position correspondence table that controls the correspondence between a program and the display position of the corresponding program selection means.

10. The control method according to claim 9, wherein in said display controlling step, the display of the program selection means of said programs to be installed is controlled so that the program selection means of said programs are arranged within the same screen on which the program selection means of said other programs are displayed.

11. The control method according to claim 9, wherein in said display controlling step, when the program selection means of said programs to be installed are arranged within a screen causing the number of the program selection means to exceed a maximum number of program selection means to be arranged within said screen, the display is controlled in such a way that at least one of the program selection means within said screen other than the respective program selection means of said programs to be installed and said other programs is moved to other screen.

12. A control method for controlling a plurality of programs, comprising:
an inputting step of inputting group identification information corresponding to a program to be processed;
a deciding step of referencing a group identification information correspondence table that controls the correspondence between a program and group identification information indicating the group to which the program belongs and deciding the presence/absence of other programs having the same group identification information as the group identification information of said programs to be processed; and
a display controlling step of controlling, when it is decided in said deciding step that said other programs exist, the display of the program selection means of said programs to be processed based on the display positions of the program selection means of said other programs controlled by the display position correspondence table that controls the correspondence between a program and the display position of the corresponding program selection means.

13. The control method according to claim 12, wherein said inputting step comprising:
a displaying step of displaying a list of group identification information of programs already installed;
a selecting step of selecting desired group identification information from the list of group identification information displayed in said displaying step; and
a setting step of setting the group identification information selected in said selecting step for said programs to be processed.

14. A control method for controlling a plurality of programs, comprising:
an specifying step of specifying programs to be uninstalled;
a first uninstalling step of uninstalling the programs specified to be uninstalled in said specifying step;
a deciding step of referencing a group identification information correspondence table that controls the correspondence between a program and group identification information indicating the group to which the program belongs and deciding the presence/absence of other programs having the same group identification information as the group identification information of said programs to be uninstalled; and
a second uninstalling step of uninstalling said other programs when it is decided in said deciding step that said other programs exist.

15. The control method according to claim 14, wherein said second uninstalling step comprising:
a displaying step of displaying said other programs; and
an instructing step of instructing execution of individual/batch uninstalling of said other programs displayed in said displaying step.

16. A control method for controlling a plurality of programs, comprising:
an inputting step of inputting group identification information;
a displaying step of referencing a group identification information correspondence table that controls the correspondence between a program and group identification information indicating the group to which the program belongs and displaying the programs having the group identification information input in said inputting step; and
an instructing step of instructing uninstalling of all said programs displayed in said displaying step.

17. A program for allowing a computer to execute control processing for controlling a plurality of programs, comprising:
a program code in an installing step of installing programs to be installed;
a program code in a deciding step of referencing a group identification information correspondence table that controls the correspondence between a program and group identification information indicating the group to which the program belongs and deciding the presence/absence of other programs having the same group identification information as the group identification information of said programs to be installed; and
a program code in a display controlling step of controlling, when it is decided in said deciding step that said other programs exist, the display of the program selection means of said programs to be installed based on the display positions of the program selection means of said other programs controlled by the display position correspondence table that controls the correspondence between a program and the display positions of the corresponding program selection means.

18. A program for allowing a computer to execute control processing for controlling a plurality of programs, comprising:
a program code in an inputting step of inputting group identification information corresponding to programs to be processed;
a program code in a deciding step of referencing a group identification information correspondence table that controls the correspondence between a program and group identification information indicating the group to which the program belongs and deciding the presence/absence of other programs having the same group identification information as the group identification information of said programs to be processed; and
a program code in a display controlling step of controlling, when it is decided in said deciding step that said other programs exist, the display of the program selection means of said programs to be processed based on the display positions of the program selection means of said other programs controlled by the display position correspondence table that controls the correspondence between a program and the display position of the corresponding program selection means.

19. A program for allowing a computer to execute control processing for controlling a plurality of programs, comprising:
a program code in an specifying step of specifying a program to be uninstalled;
a program code in a first uninstalling step of uninstalling the programs specified to be uninstalled in said specifying step;
a program code in a deciding step of referencing a group identification information correspondence table that controls the correspondence between a program and group identification information indicating the group to which the program belongs and deciding the presence/absence of other programs having the same group identification information as the group identification information of said programs to be uninstalled; and
a program code in a second uninstalling step of uninstalling said other programs when it is decided in said deciding step that said other programs exist.

20. A program for allowing a computer to execute control processing for controlling a plurality of programs, comprising:
a program code in an inputting step of inputting group identification information;
a program code in a displaying step of referencing a group identification information correspondence table that controls the correspondence between a program and group identification information indicating the group to which the program belongs and displaying the programs having the group identification information input in said inputting step; and
a program code in an instructing step of instructing uninstalling of all said programs displayed in said displaying step.

21. A control method for controlling a plurality of programs executed by an image processing apparatus allowing image scanning or image printout, comprising:
a step of storing a changeover button display order table that specifies order in which changeover buttons for switching between screens of said plurality of programs being executed are displayed;
a changeover button displaying step of displaying the changeover buttons based on said changeover button display order table;
a step of storing a starting order table that defines order in which said plurality of programs are started;
a starting step of starting said plurality of programs based on said starting order table; and
an editing step of editing said changeover button display order table and said starting order table individually.

22. The control method according to claim 21, further comprising an editable controlling step of controlling said plurality of programs by dividing the programs into a predetermined number of groups, wherein said changeover button display order table can specify the changeover button display order in said units of groups.

23. The control method according to claim 22, wherein said starting order table can specify the starting order in said units of groups.

24. The control method according to claim 22, wherein in said controlling step, said plurality of programs can be controlled in said units of groups.

25. The control method according to claim 21, wherein in said changeover button displaying step, when said changeover button display order table specifies only some of said programs, changeover buttons for switching between screens of some of said programs are displayed based on the display order specified in said changeover button display order table and changeover buttons for switching between screens of the remaining programs are displayed based on the starting order specified in said starting order table.

26. An image processing apparatus that has a plurality of programs and allows image scanning or image printout, comprising:
means for storing a changeover button display order table that specifies order in which changeover buttons for switching between screens of said plurality of programs being executed are displayed;
changeover button display means for displaying the changeover buttons based on said changeover button display order table;
means for storing a starting order table that defines order in which said plurality of programs are started;
starting means for starting said plurality of programs based on said starting order table; and
editing means for editing said changeover button display order table and said starting order table individually.

27. A control program for realizing the control method according to claim 21 using a computer.
